(19) United States
(12) Patent Application Publication
(10) Pub. No.: US 2015/0049770 A1
(43) Pub. Date: Feb. 19, 2015

(54) APPARATUS AND METHOD

(71) Applicant: Fujitsu Limited, Kawasaki-shi (JP)

(72) Inventor: Atsushi Kitada, Kawasaki (JP)

(73) Assignee: Fujitsu Limited, Kawasaki (JP)

(21) Appl. No.: 14/333,625

(22) Filed: Jul. 17, 2014

(30) Foreign Application Priority Data
Aug. 14, 2013 (JP) 2013-168424

(51) Int. Cl. H04L 12/865

(52) U.S. Cl. CPC H04L 47/6275
USPC 370/412

(57) ABSTRACT

An apparatus includes a memory; and a processor coupled to the memory and configured to: provide an acceptable read amount with a plurality of queues; discern one or more queues from among the plurality of queues as one or more prioritized queues, the one or more prioritized queues receiving packets within a receiving rate that equals to or is less than a reading rate depending on the acceptable read amount; and read one or more packets from the plurality of queues, with prioritizing the one or more prioritized queues and consuming the acceptable read amount, in order satisfying a read condition being associated with the acceptable read amount and an amount of stored packets.

### CROSS-REFERENCE TO RELATED APPLICATION

This application is based upon and claims the benefit of priority of the prior Japanese Patent Application No. 2013-168424, filed on Aug. 14, 2013, the entire contents of which are incorporated herein by reference.

### FIELD

The embodiments discussed herein are related to an apparatus and a method.

### BACKGROUND

It is desirable that a throughput of a switch device such as a Layer 2 switch or a router, in other words, a packet switching device for switching packets, is improved with an increase in demand for communication. So as to improve the throughput, improvement of a scheduling function for managing traffic by controlling readout of packets from a queue has been proposed. Japanese National Publication of International Patent Application No. 2005-510957, Japanese Laid-open Patent Publication No. 2000-244502, and Japanese Laid-open Patent Publication No. 2007-110483 discuss such a technique.

### SUMMARY

According to an aspect of the invention, an apparatus includes a memory; and a processor coupled to the memory and configured to: provide an acceptable read amount with a plurality of queues; discern one or more queues from among the plurality of queues as one or more prioritized queues, the one or more prioritized queues receiving packets within a receiving rate that equals to or is less than a reading rate depending on the acceptable read amount; and read one or more packets from the plurality of queues, with prioritizing the one or more prioritized queues and consuming the acceptable read amount, in order satisfying a read condition being associated with the acceptable read amount and an amount of stored packets.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration diagram illustrating a functional configuration of a communication device according to an embodiment;

FIG. 2 is a configuration diagram illustrating a functional configuration of a network interface card;

FIG. 3 is a diagram illustrating paths of packets within the communication device;

FIG. 4 is a configuration diagram illustrating a functional configuration of an output processing unit in a first comparative example;

FIG. 5 is a flowchart illustrating an example of an operation of a scheduler unit when a packet is input;

FIG. 6 is a flowchart illustrating an example of an operation of the scheduler unit when paying out a credit;

FIG. 7 is a configuration diagram illustrating a functional configuration of an output processing unit in a second comparative example;

FIG. 8 is a flowchart illustrating an example of an operation of a queue management unit when storing a packet in a queue;

FIG. 9 is a flowchart illustrating an example of an operation of the queue management unit when a credit is paid out;

FIG. 10 is a flowchart illustrating an example of an operation of the queue management unit when reading out a packet;

FIG. 11 is a diagram illustrating an example of a state of the queue management unit before packet readout;

FIG. 12 is a diagram illustrating an example of a state of the queue management unit after packet readout;

FIG. 13 is a diagram illustrating an example of a state after packet readout in a case where an input rate of a flow is different;

FIG. 14 is a diagram illustrating an occupancy state of a bandwidth of each flow in an output port;

FIG. 15 is a table illustrating the number of packets and a credit counter in each of a case where a debt status is not permitted and a case where a debt status is permitted;

FIG. 16 is a configuration diagram illustrating a functional configuration of an output processing unit in a first embodiment;

FIG. 17 is a flowchart illustrating an example of an operation of a queue management unit when storing a packet in a queue;

FIG. 18 is a flowchart illustrating an example of an operation of the queue management unit when a credit is paid out;

FIG. 19 is a flowchart illustrating an example of an operation of the queue management unit when reading out a packet;

FIG. 20 is a flowchart of registration processing in the first embodiment;

FIG. 21 is a table illustrating an example of a registration management table in a second embodiment;

FIG. 22 is a flowchart of registration processing in the second embodiment;

FIG. 23 is a configuration diagram illustrating examples of configurations of a priority list and a non-priority list;

FIGS. 24A and 24B are configuration diagrams illustrating examples of states of the priority list and the non-priority list before and after a change of registration;

FIG. 25 is a flowchart of registration processing in a third embodiment;

FIG. 26 is a table illustrating an example of a registration management table in a fourth embodiment;

FIG. 27 is a flowchart of registration processing in the fourth embodiment;

FIG. 28 is a configuration diagram illustrating a concept of a bandwidth determination function of a policer;

FIG. 29 is a configuration diagram illustrating a functional configuration of an output processing unit in a fifth embodiment;

FIG. 30 is a flowchart of registration processing in the fifth embodiment;

FIG. 31 is a configuration diagram illustrating a functional configuration of an output processing unit in a sixth embodiment;

FIG. 32 is a configuration diagram illustrating a configuration of a packet of a voice over Internet protocol (VoIP);

FIG. 33 is a flowchart of registration processing in the sixth embodiment;

FIG. 34 is a configuration diagram illustrating a simulation model; and

FIGS. 35A and 35B are graphs illustrating simulation results of maximum delay times of packets in a comparative example and an embodiment.

### DESCRIPTION OF EMBODIMENTS

First, a consideration by the inventor will be described. In a case where a queue serving as a subsequent readout target is selected based on scheduling every time one packet is read out from a queue, a processing time permitted for the scheduling is restricted to the time of readout processing for the packet. Therefore, in a case where the length of the packet is variable in such a manner as in, for example, an Ethernet (registered trademark: the same shall apply hereafter) frame, a processing time permitted for the scheduling depends on the length of the packet read out (in other words, a data amount).

When it is assumed that a communication speed is, for example, 100 (Gbps), the processing time permitted for the scheduling is about 6.7 (ns) in a case of a packet whose length is 64 (Byte) while being about 121 (ns) in a case of a packet whose length is 1500 (Byte). In other words, when short packets are continuously read out, the processing time permitted for the scheduling is restricted to a relatively short time. Therefore, high processing performance is desired for the scheduling.

For example, in a case of only reading out short packets, it is desirable that the scheduling has a processing speed of about 148.8 (M packets per second (pps)). In this case, when it is assumed that the operating frequency of packet processing is 300 (MHz), one short packet turns out to be processed by 2 clocks (300 (MHz)/2=150 (Mpps)≈148.8 (Mpps)). In a case where the number of queues is large or a case where a complicated algorithm is used for the scheduling, a requested processing speed becomes higher.

In contrast, if a plurality of packets are treated as bursty traffic so as to be continuously read out and scheduling processing is performed not by one packet but by a predetermined data amount, restriction of a time permitted for the scheduling is relaxed. For example, in a case where the scheduling processing is performed by 2500 (Byte), if an operating frequency is 300 (MHz), a throughput of 100 (Gbps) (=2500 (Byte)/200 (ns)) in a processing time (200 (ns)) of 60 clocks is realized. In other words, according to this burst-data-based scheduling method (hereinafter, expressed by a “burst scheduling method”), it becomes possible to relax restriction of a time permitted for the scheduling.

In the case of the burst scheduling method, so as to read out a predetermined data amount from each queue, the corresponding data amount is assigned to each queue, as the permissible amount of readout indicating the data amount of packets capable of being read out. In a case where the permissible amount of readout a queue holds is larger than zero, packets accumulated in a queue are read out by consuming the permissible amount of readout.

At this time, since it is difficult to divide and read out one packet, packets whose data amount exceeds the permissible amount of readout each queue holds are read out from the queue. For example, in a case where a packet whose length is 9600 (Byte) (jumbo frame) is accumulated in a queue, the packet is read out even if the relevant queue only holds the permissible amount of readout corresponding to 100 (Byte). At this time, the permissible amount of readout after readout becomes −9500 (Byte) (=100 (Byte)−9600 (Byte)). In this way, a status where the permissible amount of readout is a negative value is expressed by a “debt status” in the present specification.

Packets are divided into individual flows and stored in queues. Each of the flows is a class determined in response to, for example, destinations or the like of individual packets. The readout rates of packets are individually controlled by shapers for respective flows. Each shaper controls the permissible amount of readout assigned to a corresponding queue so that the sum of readout rates of individual flows becomes less than or equal to the bandwidth of an output port outputting packets read out.

However, in a case where, in such a manner as in best effort traffic, the bandwidth is not controlled and the number of flows input at rates exceeding bandwidths shapers control is large, a debt status frequently occurs and the bandwidth of the output port is squeezed. Therefore, there is a problem that a delay or a fluctuation on a millisecond time scale occurs in a packet of a flow bandwidth-guaranteed in such a manner as in, for example, audio system data or finance system data and communication quality is deteriorated. In addition, such a problem is not limited to the Ethernet frame, and exists in another packet such as an Internet protocol (IP) packet, in the same way.

Therefore, the present technology is made in view of the above-mentioned problem, and provides a communication device and a packet scheduling method in which communication quality is improved.

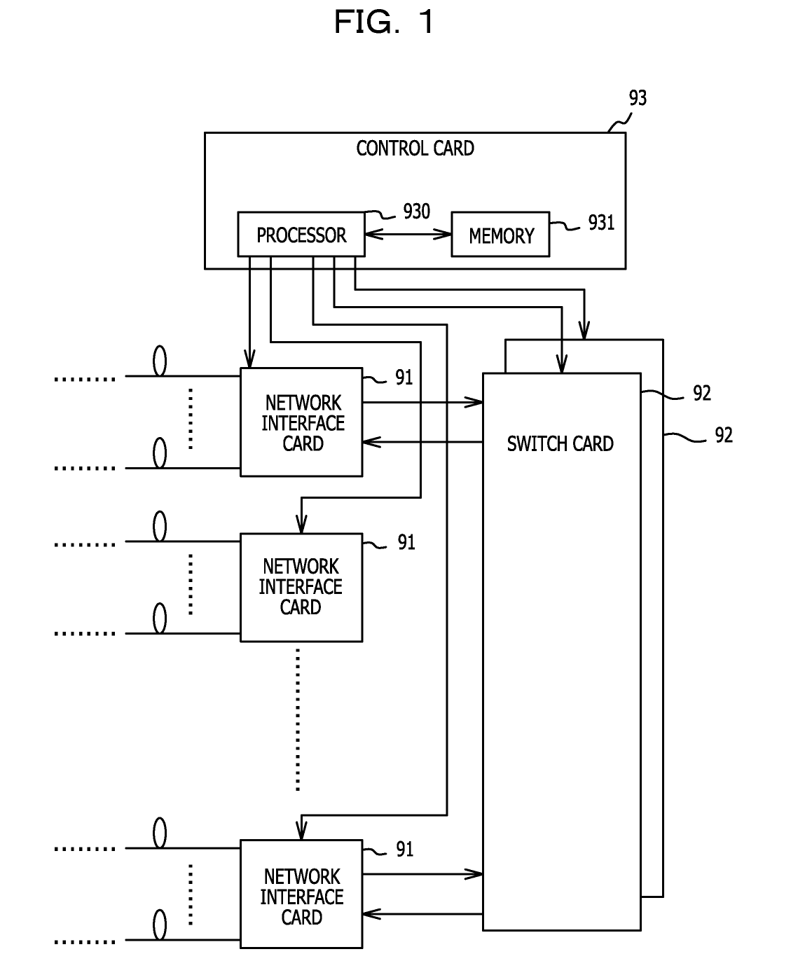

FIG. 1 is a configuration diagram illustrating the functional configuration of a communication device according to an embodiment. The communication device includes a plurality of network interface cards 91, two switch cards 92, and a control card 93. The individual cards 91 to 93 are contained in individual slots provided in an enclosure, and electrically connected to one another. In addition, while, in the present specification, a packet switching device such as a Layer 2 switch or a router will be cited as an example of the communication device, the communication device is not limited to this.

The communication device relays a packet received from an external device, to another external device in accordance with the destination thereof. In addition, in the present specification, the packet means the transmission unit of transmitted data (information), and an Ethernet frame is cited as an example. However, the packet is not limited to this, and may be another frame such as an IP packet.

The plural network interface cards 91 each transmit and receive packets to and from an external device. As examples of the external device, a terminal device such as a personal computer, a server device, are a router are cited. The plural network interface cards 91 are connected to an optical fiber using a plurality of ports, and perform communication based on, for example, 10GBASE-LR.

The two switch cards 92 each switch packets between the plural network interface cards 91. More specifically, a packet is input from one network interface card 91 to one of the switch cards 92, and the switch card 92 outputs the packet to another network interface card 91 corresponding to the destination thereof. The two switch cards 92 are used as a currently-used system and a backup system in preparation for, for example, a failure such as a hardware fault.

The control card 93 controls the plural network interface cards 91 and the two switch cards 92. The control card 93 is connected to a network control device or the like, and performs processing relating to a user interface, setting processing for the individual cards 91 and 92, and processing for collecting information from the individual cards 91 and 92. The control card 93 includes a processor 930 such as a central processing unit (CPU) executing these processing operations, and a memory 931 storing therein a program for driving the processor 930.

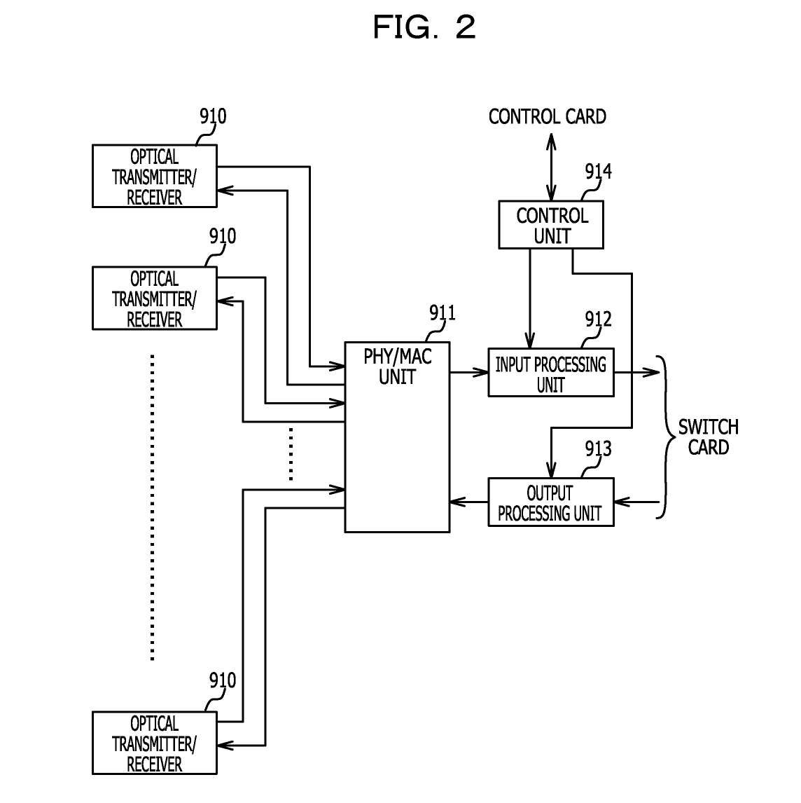

FIG. 2 is a configuration diagram illustrating the functional configuration of one of the network interface cards 91. The network interface card 91 includes a plurality of optical transmitters/receivers 910, a PHY/MAC unit 911, an input processing unit 912, an output processing unit 913, and a control unit 914.

The plural optical transmitters/receivers 910 each convert an optical signal received from an external device through the optical fiber, into an electric signal, and output the electric signal to the PHY/MAC unit 911. In addition, the plural optical transmitters/receivers 910 each convert an electric signal input from the PHY/MAC unit 911, into an optical signal, and transmit the optical signal to an external device through the optical fiber. In other words, the plural optical transmitters/receivers 910 each function as a port for transmitting and receiving packets to and from an external device.

The PHY/MAC unit 911 performs processing for establishing a link with an external device, and processing for distributing packets to the plural optical transmitters/receivers 910. The PHY/MAC unit 911 outputs packets input from the plural optical transmitters/receivers 910, to the input processing unit 912, and outputs packets input from the output processing unit 913, to the plural optical transmitters/receivers 910.

The input processing unit 912 and the output processing unit 913 perform packet processing operations for an ingress (INGRESS) and an egress (EGRESS), respectively. The input processing unit 912 performs bandwidth control processing or the like for packets, and outputs the packets to one of the switch cards 92. The output processing unit 913 performs bandwidth control processing or the like for packets input from the switch card 92, and output the packets to the PHY/MAC unit 911.

The control unit 914 performs communication with the control card 93, and controls the input processing unit 912 and the output processing unit 913. The control unit 914 includes a processor such as a CPU and a memory (not illustrated).

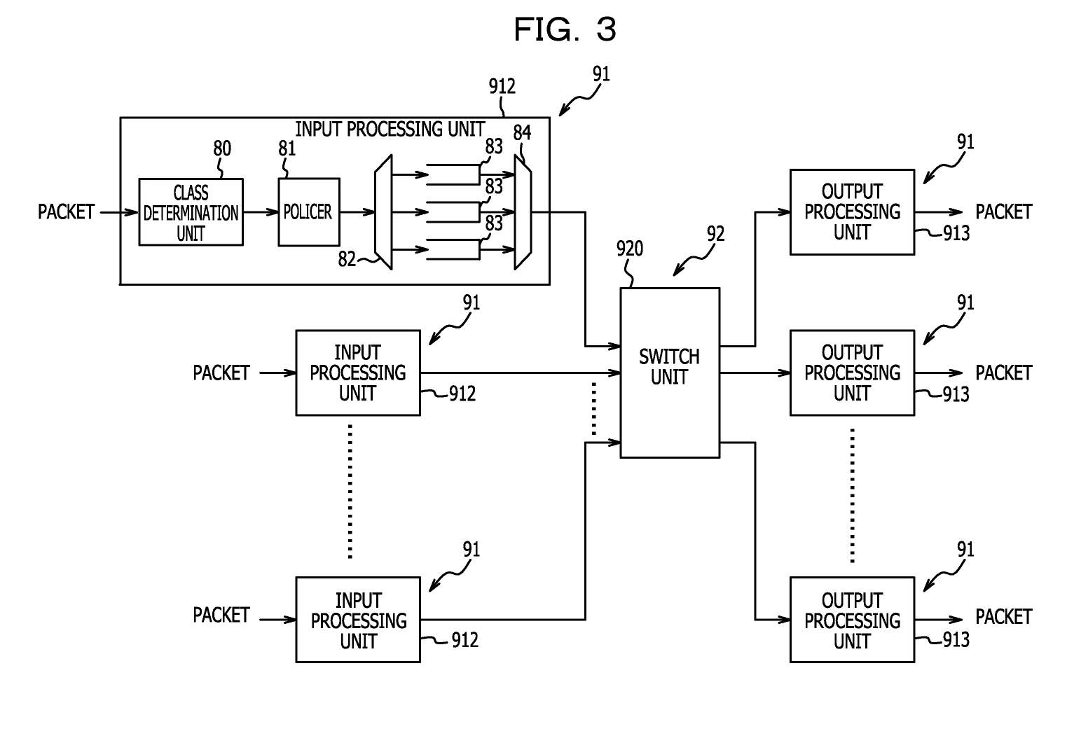

FIG. 3 illustrates paths of packets within the communication device. In addition, FIG. 3 illustrates the configuration of one of the input processing units 912.

First, a packet is input to the input processing unit 912 in the network interface card 91. The input processing unit 912 includes a class determination unit 80, a policer 81, a distribution unit 82, a plurality of input queues 83, and an output unit 84.

The class determination unit 80 determines a class of communication quality (Quality of Service: QoS) of each packet, and assigns a flow ID corresponding the class to the packet while causing the flow ID to be included in, for example, a within-device header. The class determination unit 80 determines the class, based on, for example, a destination (destination address: DA) included in the header of the packet or a virtual local area network (VLAN) ID.

The policer 81 discards packets corresponding to an amount exceeding a predetermined bandwidth so that the traffic amount of input packets does not exceed the predetermined bandwidth. The distribution unit 82 distributes a packet to one of the plural input queues 83 in response to a corresponding network interface card 91 serving as a destination. In other words, the input queues 83 are provided for respective network interface cards 91. The plural input queues 83 accumulate therein packets until the packets are read out by the output unit 84. The output unit 84 selects one from among the plural input queues 83, reads out a packet from the selected input queue 83, and outputs the packet to a switching unit 920 in the switch card 92. The switching unit 920 outputs the input packet to the output processing unit 913 in one of the network interface cards 91 corresponding to the destination.

### First Comparative Example

First, a comparative example of the burst scheduling method will be described. In the burst scheduling method, a scheduling function is provided independently from a readout function for packets, and assigns, to each queue, the permissible amount of readout indicating the data amount of packets capable of being read out. In addition, the permissible amount of readout is expressed by a “credit” in the following description.

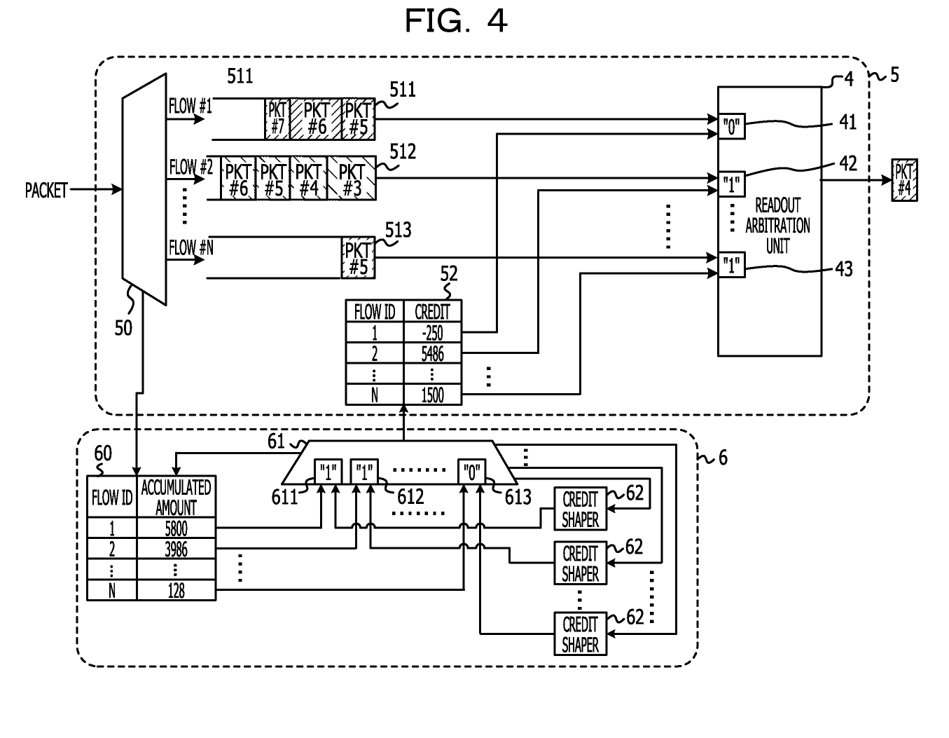

FIG. 4 is a configuration diagram illustrating the functional configuration of the output processing unit 913 in a first comparative example. The output processing unit 913 includes a queue management unit 5 and a scheduler unit 6. The queue management unit 5 includes a distribution unit 50, a plurality of queues 511 to 513, a credit counter unit 52, and a readout arbitration unit 4, and reads out packets from the plural queues 511 to 513 by consuming credits. The scheduler unit 6 includes an accumulated-amount counter unit 60, a credit payout unit 61, and a plurality of credit shapers 62, and pays out credits to the queue management unit 5.

The distribution unit 50 distributes input packets to the plural queues 511 to 513, based on flow IDs. The plural queues 511 to 513 each accumulate therein one or more packets. In addition, the distribution unit 50 notifies the scheduler unit 6 of the flow IDs and the packet lengths of the input packets.

Based on the notification from the distribution unit 50 and credit amounts assigned to the queues, the accumulated-amount counter unit 60 virtually counts the data amount of packets of each flow ID. In the example of FIG. 4, data of 5800 (Byte) is accumulated in the queue 511 corresponding to a flow #1, data of 3986 (Byte) is accumulated in the queue 512 corresponding to a flow #2, and data of 128 (Byte) is accumulated in the queue 513 corresponding to a flow #N. In addition, in the following description, a data amount the accumulated-amount counter unit 60 counts is expressed by an “accumulated-amount counter”.

The credit shapers 62 are provided for the respective flows #1 to #N, and adjusts intervals at which credits are assigned to the queues 511 to 513 of the relevant flows. The credit shapers 62 each include, for example, a token bucket saving therein a token treated as a transmission right, and regulate payout of the credit in accordance with the remaining amount of the token. The credit shapers 62 each adjust an interval at which the credit is assigned, based on the supply rate of the token.

The credit payout unit 61 pays out a certain credit to the queue management unit 5. In other words, the credit payout unit 61 assigns a certain credit to each of the plural queues 511 to 513. The credit payout unit 61 includes payout flags 611 to 613 indicating the availability of credits for the queues 511 to 513, respectively.

The payout flags 611 to 613 each indicate “1” in a case where payout of a credit is available, and “0” in a case where payout of a credit is unavailable. The payout flags 611 to 613 are each set to “1” in a case where the accumulated-amount counter of a corresponding flow is greater than or equal to a predetermined amount B and the remaining amount of a token of the corresponding credit shaper 62 is greater than zero.

In the example of FIG. 4, when it is assumed that the predetermined amount B is 1500 (Byte), the accumulated-amount counter (128 (Byte)) of the flow #N is smaller than the predetermined amount B. Therefore, the payout flag 613 indicates “0”. In addition, since the accumulated-amount counters of the other flows #1 and #2 are larger than the predetermined amount B, the other payout flags 611 and 612 indicate “1”. In this way, a credit is assigned to a queue where the data amount of accumulated packets is greater than or equal to the certain amount of B, from among the plural queues 511 to 513. Therefore, by reading out packets as a traffic having a certain burst property, it is possible to improve a throughput.

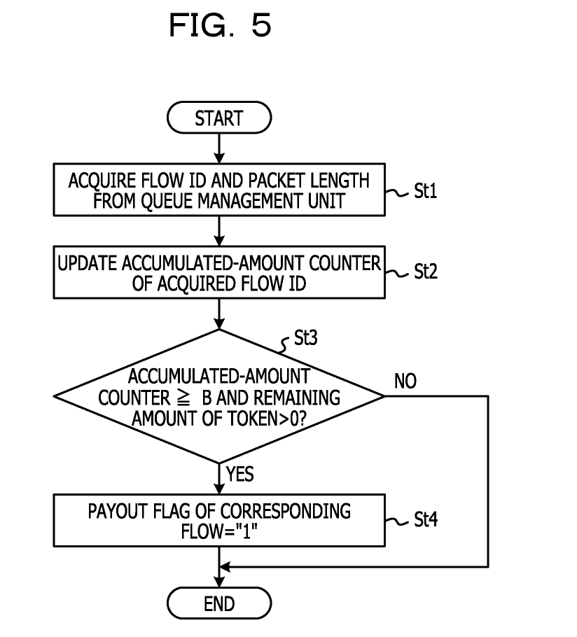

FIG. 5 is a flowchart illustrating an example of the operation of the scheduler unit 6 when a packet is input. First, the accumulated-amount counter unit 60 acquires a flow ID and a packet length from the queue management unit 5 (step St1). Next, based on the acquired flow ID and packet length, the accumulated-amount counter unit 60 updates the accumulated-amount counter of a corresponding one of the flows #1 to #N (step St2). Next, the credit payout unit 61 determines whether a payout condition that the accumulated-amount counter of the corresponding one of the flows #1 to #N is greater than or equal to the predetermined amount B and the remaining amount of a token of the corresponding credit shaper 62 is greater than zero is satisfied or not (step St3).

In a case where the payout condition is satisfied (step St3: Yes), the credit payout unit 61 sets a corresponding one of the payout flags 611 to 613 of the flows #1 to #N to “1” (step St4), and terminates the processing. On the other hand, in a case where the payout condition is not satisfied (step St3: No), the credit payout unit 61 terminates the processing. In this way, the scheduler unit 6 performs the processing when a packet is input.

The credit payout unit 61 pays out a certain credit to one of the queues 511 to 513 of the flows #1 to #N where a corresponding one of the payout flags 611 to 613 indicates “1”.

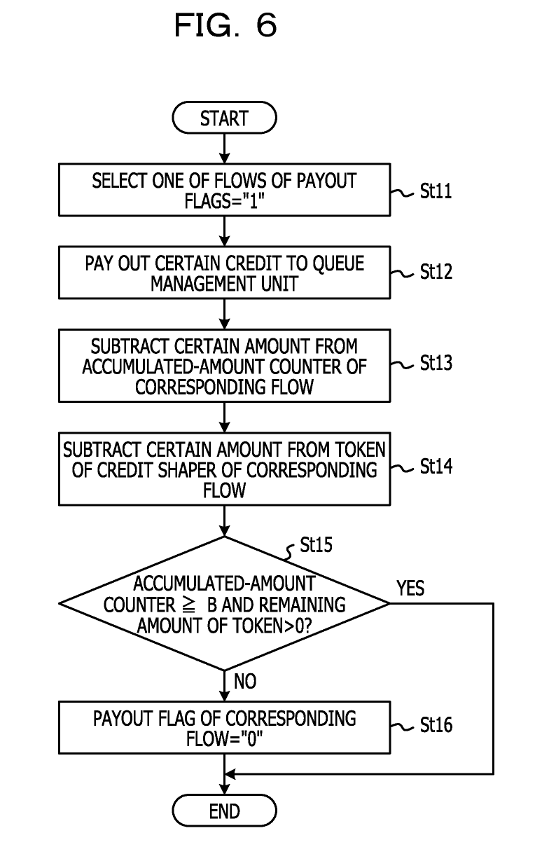

FIG. 6 is a flowchart illustrating an example of the operation of the scheduler unit 6 when paying out a credit. First, the credit payout unit 61 selects one of the flows #1 to #N where a corresponding one of the payout flags 611 to 613 indicates “1” (step St11). The credit payout unit 61 may select one of the flows #1 to #N using, for example, a round-robin method, and may select one or more specific flows out of the flows #1 to #N on a priority basis.

Next, the credit payout unit 61 pays a credit to the queue management unit 5 (step St12). In other words, the scheduler unit 6 assigns a certain credit to a corresponding one of the plural queues 511 to 513. The credit paid out is counted by the credit counter unit 52 in the queue management unit 5.

The credit counter unit 52 counts a credit with respect to each flow ID, in other words, each of the queues 511 to 513. In the example of FIG. 4, the queue 511 of the flow #1 has a credit of −250 (Byte), and the queue 512 of the flow #2 has a credit of 5486 (Byte). In addition, the queue 513 of the flow #N has a credit of 1500 (Byte). The scheduler unit 6 pays out a credit to each of the queues 511 to 513 by a certain amount. In addition, in the following description, the amount of a credit the credit counter unit 52 counts is expressed by a “credit counter”.

Next, the credit payout unit 61 subtracts a certain amount from the accumulated-amount counter of a corresponding one of the flows #1 to #N (step St13). In other words, under the assumption that packets corresponding to a credit are read out when the credit is paid out, the credit payout unit 61 updates the accumulated-amount counter in the accumulated-amount counter unit 60. Therefore, in some cases, the accumulated-amount counter is not identical to the sum of the data amounts of packets accumulated in a corresponding one of the individual queues 511 to 513, and indicates a virtually accumulated amount. Accordingly, the accumulated-amount counter becomes a negative value when the credit paid out exceeds the sum of the data amounts of packets accumulated in a corresponding one of the individual queues 511 to 513.

Next, the credit payout unit 61 subtracts a certain amount from a token of the credit shaper 62 of a corresponding one of the flows #1 to #N (step St14). In other words, the credit payout unit 61 pays out a credit by consuming the token. Accordingly, the amount of a credit paid out to each of the queues 511 to 513 within a unit time (in other words, a payout rate) is controlled by the credit shaper 62 of a corresponding one of the individual flows #1 to #N.

Next, the credit payout unit 61 determines whether the payout condition that the accumulated-amount counter of the corresponding one of the flows #1 to #N is greater than or equal to the predetermined amount B and the remaining amount of a token of the corresponding credit shaper 62 is greater than zero is satisfied or not (step St15).

In a case where the payout condition is not satisfied (step St15: No), the credit payout unit 61 sets a corresponding one of the payout flags 611 to 613 of the flows #1 to #N to “0” (step St16), and terminates the processing. On the other hand, in a case where the payout condition is satisfied (step St15: Yes), the credit payout unit 61 terminates the processing. In this way, the scheduler unit 6 performs the processing when a credit is paid out.

On the other hand, in the queue management unit 5, the readout arbitration unit 4 reads out a packet by consuming a credit, with respect to each of the queues 511 to 513. The readout arbitration unit 4 includes readout flags 41 to 43 for the flows #1 to #N, respectively. Each of the readout flags 41 to 43 indicates “1” in a case where a readout condition relating to a credit of a corresponding one of the queues 511 to 513 and the data amount of packets accumulated in the corresponding one of the queues 511 to 513 is satisfied, and indicates “0” in a case where the readout condition is not satisfied.

The readout condition is satisfied in a case where a credit of one of the queues 511 to 513 and the data amount of packets accumulated in the corresponding one of the queues 511 to 513 are greater than zero. In other words, in a case where packets are stored in one of the queues 511 to 513 and a corresponding credit counter is a positive value, the readout arbitration unit 4 reads out packets from the corresponding one of the queues 511 to 513.

In the example of FIG. 4, packets are stored in the individual queues 511 to 513, and the credit counter of the flow #1 is −250. Therefore, the readout flag 41 is set to “0”. In addition, since the credit counters of the other flows #2 and #N are positive values, the readout flags 42 and 43 are set to “1”. According to this readout condition, if a credit of at least one (Byte) and at least one packet exists, the relevant packet is read out from one of the queues 511 to 513 regardless of the packet length thereof. Therefore, a waiting time of a packet is reduced and a throughput is improved.

The readout arbitration unit 4 reads out a packet from one of the queues 511 to 513 corresponding to the flows #1 to #N, respectively, where a corresponding one of the readout flags 41 to 43 indicates “1”. In a case where the plural readout flags 41 to 43 indicate “1”, the readout arbitration unit 4 selects a queue to be a readout target of a packet, from among the plural queues 511 to 513. In other words, the readout arbitration unit 4 arbitrates competition of readout between the plural queues 511 to 513.

When it is assumed that a new scheduler is provided as the readout arbitration unit 4, separation of the scheduler unit 6 becomes less meaningful. So as to select, in accordance with a predetermined scheduling algorithm, one queue from among queues from which packets are able to be read out, the scheduler performs search processing based on a parameter such as the priority or weight of each flow. A time taken for this search processing increases with an increase in the number of patterns of queues capable of being subjected to readout, and in a case where the number of queues is large and in a case where an algorithm is complex, much more time is taken. Accordingly, it is desirable that the readout arbitration unit 4 where the burden of the search processing does not exist or is small is used.

### Second Comparative Example

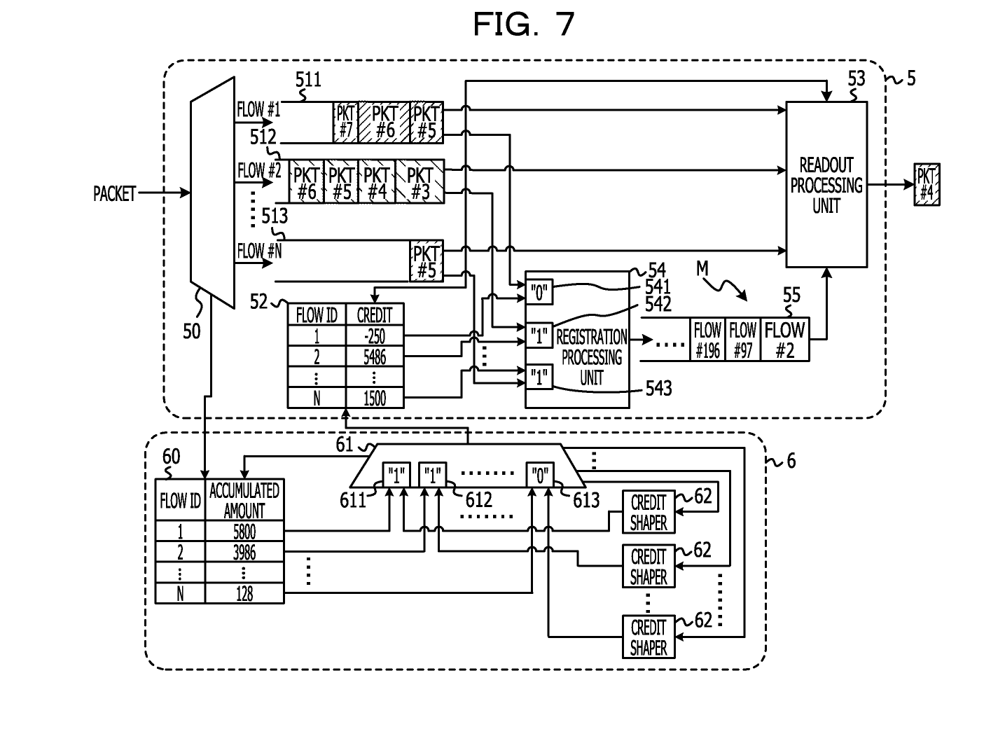

Therefore, a communication device according to a second comparative example uses a method where the queues 511 to 513 notify the readout arbitration unit 4 of states of being able to be subjected to readout, without using the above-mentioned search processing. FIG. 7 is a configuration diagram illustrating the functional configuration of an output processing unit 913 in the second comparative example. In addition, in FIG. 7, the same symbol is assigned to a configuration in common with FIG. 4, and the description thereof will be omitted.

The output processing unit 913 includes the queue management unit 5 and the scheduler unit 6. The queue management unit 5 includes the distribution unit 50, the plural queues 511 to 513, the credit counter unit 52, a readout processing unit 53, a registration processing unit 54, and a memory M storing therein a readout order registration list 55. The scheduler unit 6 includes the accumulated-amount counter unit 60, the credit payout unit 61, and the plural credit shapers 62. In addition, the operation of the scheduler unit 6 is as described with reference to FIG. 4.

The registration processing unit 54 determines whether or not one of the queues 511 to 513 satisfies the readout condition, and registers, in the readout order registration list 55, the flow ID of one of the queues 511 to 513 satisfying the readout condition. The registration processing unit 54 includes readout flags 541 to 543 for the queues 511 to 513, respectively. The contents of the readout flags 541 to 543 are the same as those of the readout flags 41 to 43 described with reference to FIG. 4, and the readout condition is as described above.

The registration processing unit 54 registers the flow ID of each of the queues 511 to 513 in the readout order registration list 55 in order of satisfying the readout condition. The readout processing unit 53 reads out a flow ID from the readout order registration list 55, and reads out a packet from one of the queues 511 to 513 that corresponds to the relevant flow, by consuming a credit. At this time, the readout processing unit 53 reads out a leading flow ID, in other words, a flow ID earliest registered in terms of time, from among the flow IDs registered in the readout order registration list 55.

In other words, by consuming credits, the readout processing unit 53 reads out packets from the plural queues 511 to 513 in order of satisfying the readout conditions relating to credits of individual queues and the data amounts of packets accumulated in individual queues. In the example of FIG. 7, packets are read out from queues corresponding to the flow #2, a flow #97, and a flow #196 in this order. In this way, the readout processing unit 53 simply determines queues serving as readout targets in accordance with the flow IDs registered in the readout order registration list 55, without performing complicated search processing. Therefore, it is possible to perform readout processing in less time. In addition, a time interval at which a credit is paid out is controlled by the credit shaper 62. Therefore, the readout rate of a packet from the readout processing unit 53, in other words, an output rate at which a packet is output from a port, is controlled by the credit shaper 62.

In a case where one of the queues 511 to 513 further satisfies the readout condition after a packet is read out from the relevant queue, the registration processing unit 54 re-registers the corresponding flow ID in the readout order registration list 55. Incidentally, in a case of reading out packets until a credit becomes less than or equal to zero, the registration processing unit 54 does not perform the registration processing for the flow ID. The registration processing for the flow ID is performed with triggered by an event where the readout condition is satisfied. This event is storage of a packet in one of the queues 511 to 513, payout of a credit from the scheduler unit 6, or readout of a packet from one of the queues 511 to 513. Hereinafter, the operation of the queue management unit 5 in each event will be described.

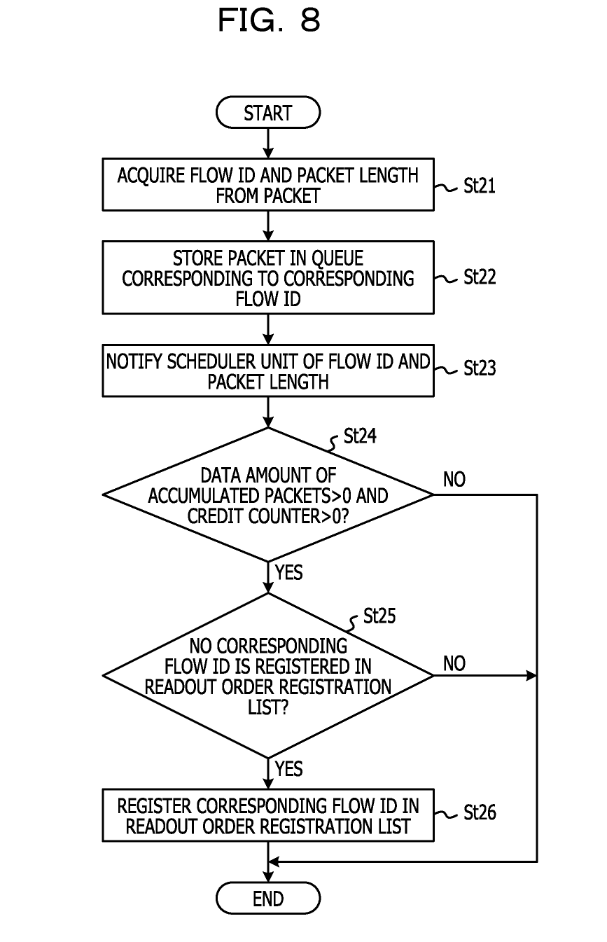

FIG. 8 is a flowchart illustrating an example of the operation of the queue management unit 5 when storing a packet in one of the queues 511 to 513. First, the distribution unit 50 acquires a flow ID and a packet length from a packet input from the switch card 92 (step St21).

Next, the distribution unit 50 stores the packet in one of the queues 511 to 513 that corresponds to the acquired flow ID (step St22). Next, the distribution unit 50 notifies the scheduler unit 6 of the acquired flow ID and packet length (step St23). Next, the registration processing unit 54 determines whether the readout condition that the data amount of packets accumulated in the one queue of the queues 511 to 513 that corresponds to the relevant flow ID is greater than zero and a credit counter corresponding to the relevant flow ID is greater than zero is satisfied or not (step St24).

In a case where the readout condition is not satisfied (step St24: No), the queue management unit 5 terminates the processing. On the other hand, in a case where the readout condition is satisfied (step St24: Yes), the registration processing unit 54 determines the presence or absence of registration of the relevant flow ID in the readout order registration list 55 (step St25). In a case where the relevant flow ID is registered (step St25: No), the queue management unit 5 terminates the processing.

On the other hand, in a case where the relevant flow ID is not registered (step St25: Yes), the registration processing unit 54 registers the relevant flow ID in the readout order registration list 55 (step St26), and the queue management unit 5 terminates the processing. In this way, the queue management unit 5 performs the processing at the time of inputting a packet.

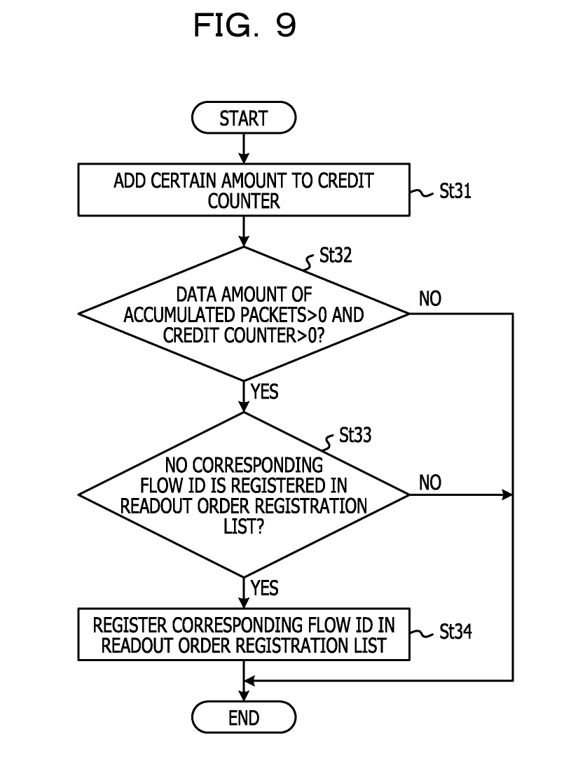

In addition, FIG. 9 is a flowchart illustrating an example of the operation of the queue management unit 5 when a credit is paid out. First, the credit counter unit 52 adds a certain amount of credit paid out from the scheduler unit 6, to the credit counter of a corresponding flow ID (step St31).

Next, the registration processing unit 54 determines whether the readout condition that the data amount of packets accumulated in the one queue of the queues 511 to 513 that corresponds to the relevant flow ID is greater than zero and a credit counter corresponding to the relevant flow ID is greater than zero is satisfied or not (step St32). In a case where the readout condition is not satisfied (step St32: No), the queue management unit 5 terminates the processing.

On the other hand, in a case where the readout condition is satisfied (step St32: Yes), the registration processing unit 54 determines the presence or absence of registration of the relevant flow ID in the readout order registration list 55 (step St33). In a case where the relevant flow ID is registered (step St33: No), the queue management unit 5 terminates the processing.

On the other hand, in a case where the relevant flow ID is not registered (step St33: Yes), the registration processing unit 54 registers the relevant flow ID in the readout order registration list 55 (step St34), and the queue management unit 5 terminates the processing. In this way, the queue management unit 5 performs the processing when a credit is paid out.

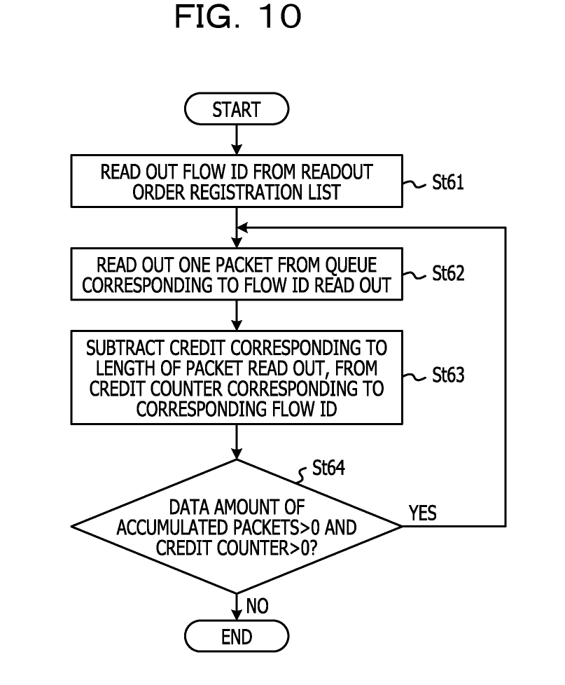

In addition, FIG. 10 is a flowchart illustrating an example of the operation of the queue management unit 5 when reading out a packet. First, the readout processing unit 53 reads out a leading flow ID from the readout order registration list 55 (step St61). The flow ID read out is deleted from the readout order registration list 55.

Next, the readout processing unit 53 reads out one packet from one of the queues 511 to 513 that corresponds to the flow ID read out (step St62). Next, the readout processing unit 53 subtracts a credit corresponding to the length of the packet read out, from a credit counter corresponding to the relevant flow ID (step St63). In other words, by consuming credits, the readout processing unit 53 reads out packets from the plural queues 511 to 513 in order of satisfying the readout conditions relating to credits of individual queues and the data amounts of packets accumulated in individual queues.

Next, the registration processing unit 54 determines whether the readout condition that the data amount of packets accumulated in the one queue of the queues 511 to 513 that corresponds to the relevant flow ID is greater than zero and a credit counter of the relevant flow ID is greater than zero is satisfied or not (step St64). In a case where the readout condition is not satisfied (step St64: No), the queue management unit 5 terminates the processing.

On the other hand, in a case where the readout condition is satisfied (step St64: Yes), the processing operation in the step St62 is performed again. In this way, the queue management unit 5 performs the processing at the time of reading out a packet. In addition, in the example of FIG. 10, the readout processing unit 53 continuously reads out packets until the readout condition becomes unsatisfied. However, in contrast to this, packets may be read out one by one or packets corresponding to a certain amount of data may be read out. In this case, every time readout is performed, the registration processing unit 54 determines whether or not the readout condition is satisfied, and in a case where the readout condition is satisfied, the registration processing unit 54 re-registers the corresponding flow ID in the readout order registration list 55.

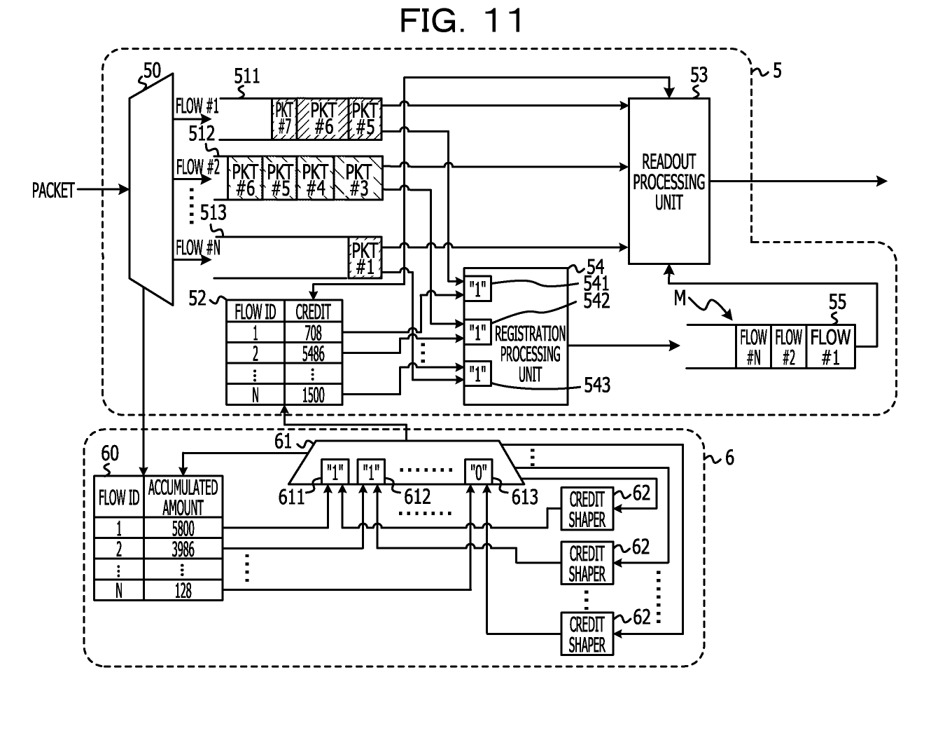

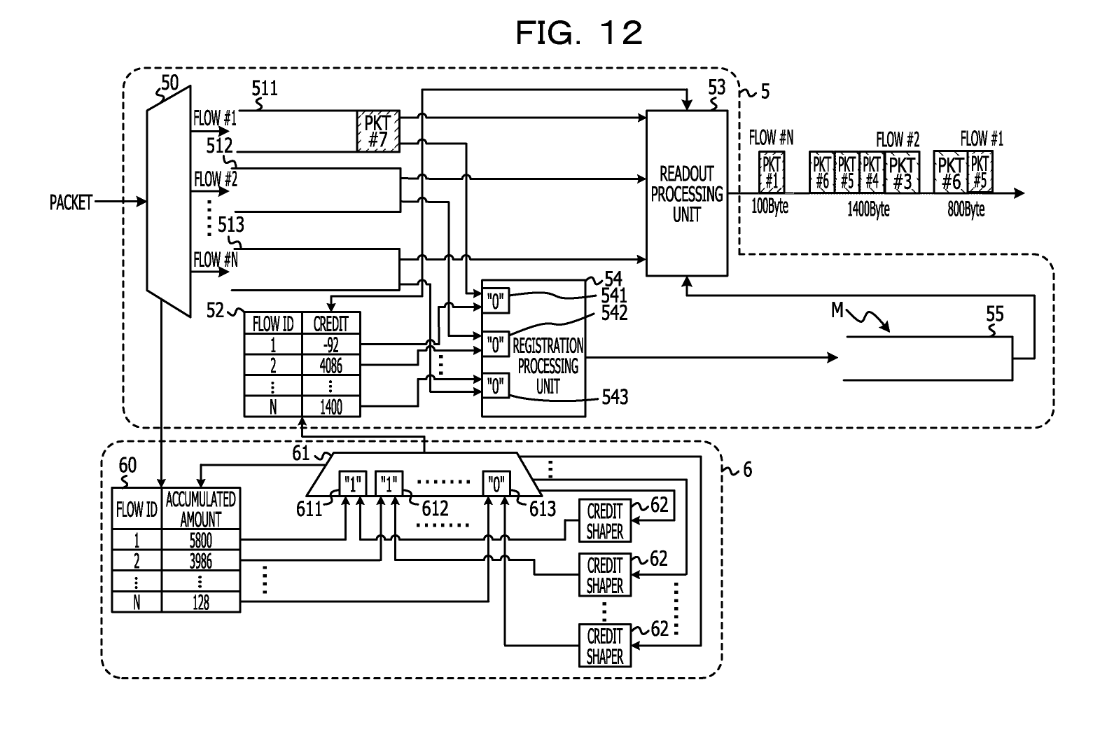

A specific example of this packet readout operation will be described with reference to FIG. 11 and FIG. 12. FIG. 11 illustrates an example of a state of the queue management unit 5 before packet readout. FIG. 12 illustrates an example of a state of the queue management unit 5 after packet readout.

Before readout, as for flow IDs, the flow #1, the flow #2, and the flow #N are registered in the readout order registration list 55 in this order. In addition, the credit counter of the flow #1 is 708 (Byte), the credit counter of the flow #2 is 5486 (Byte), and the credit counter of the flow #N is 1500 (Byte).

In accordance with the order of the flow IDs registered in the readout order registration list 55, first the readout processing unit 53 continuously reads out PKT #5 and PKT #6 (the sum of data amounts is 800 (Byte)) from the queue 511 of the flow #1. At this time, a credit corresponding to the length, 800 (Byte), of PKT #5 and PKT #6 already read out is subtracted from the credit counter of the flow #1, and the credit counter of the flow #1 becomes −92 (Byte). At this time point, the queue 511 of the flow #1 does not satisfy the readout condition (step St64: No). Therefore, the readout processing unit 53 terminates readout of a packet from the queue 511 of the flow #1.

Next, the readout processing unit 53 continuously reads out PKT #3 to PKT #6 (the sum of data amounts is 1400 (Byte)) from the queue 512 of the flow #2. At this time, a credit corresponding to the length, 1400 (Byte), of PKT #3 to PKT #6 already read out is subtracted from the credit counter of the flow #2, and the credit counter of the flow #2 becomes 4086 (Byte). At this time point, the queue 512 of the flow #2 becomes empty, and hence, does not satisfy the readout condition (step St64: No). Therefore, the readout processing unit 53 terminates readout of a packet from the queue 512 of the flow #2.

Finally, the readout processing unit 53 reads out PKT #1 (the data amount thereof is 100 (Byte)) from the queue 513 of the flow #N. At this time, a credit corresponding to the length, 100 (Byte), of PKT #1 already read out is subtracted from the credit counter of the flow #N, and the credit counter of the flow #N becomes 1400 (Byte). At this time point, the queue 513 of the flow #N becomes empty, and hence, does not satisfy the readout condition (step St64: No). Therefore, the readout processing unit 53 terminates readout of a packet from the queue 513 of the flow #N.

In this way, the readout processing unit 53 continuously reads out packets from a queue out of the plural queues 511 to 513, the queue satisfying the readout condition, until the readout condition becomes unsatisfied. Therefore, while the burst property of a traffic becomes higher than a case where only one packet is read out in one readout processing operation, the frequency of the readout processing operation becomes lower than this case. Therefore, the load of the readout processing unit 53 is reduced. Furthermore, since a plurality of packets are read out in one readout processing operation, the throughput of the communication device is improved.

In addition, as described above, at the time of the occurrences of individual events of storage of a packet, payout of a credit, and readout of a packet, the registration processing unit 54 registers flow IDs in the readout order registration list 55. Since the individual events do not simultaneously occur, the registration processing unit 54 does not arbitrate competition of registration at the time of registration of the flow IDs.

The reasons are as follows. First, since packets are sequentially input from the switch card 92 to the output processing unit 913 one by one, events of storage of packets do not simultaneously occur. Since payout of a credit and readout of a packet are sequentially performed with respect to each flow, these events do not simultaneously occur. In addition, the simultaneous occurrences of different events are avoided by adjusting clock timings synchronized with the processing operations of individual events so that the timings of the occurrences of the events are deviated from one another.

In the present comparative example, with triggered by the occurrences of the above-mentioned events, the registration processing unit 54 registers corresponding flow IDs in the readout order registration list 55 in order of satisfying the readout condition. In addition, the readout processing unit 53 acquires the registered flow IDs in order, from the leading, and reads out a packet from one of the queues 511 to 513 that corresponds to the acquired flow ID. Therefore, it is possible for the readout processing unit 53 to select one of the queues 511 to 513 and read out a packet, using simple processing whose load is light, without performing search processing for which much time is taken.

However, in the present comparative example, as described later, in a case where input rates of individual flows are different, a flow input at a rate exceeding an output rate determined by the credit shaper 62 squeezes the bandwidth of a flow input at a rate less than or equal to an output rate.

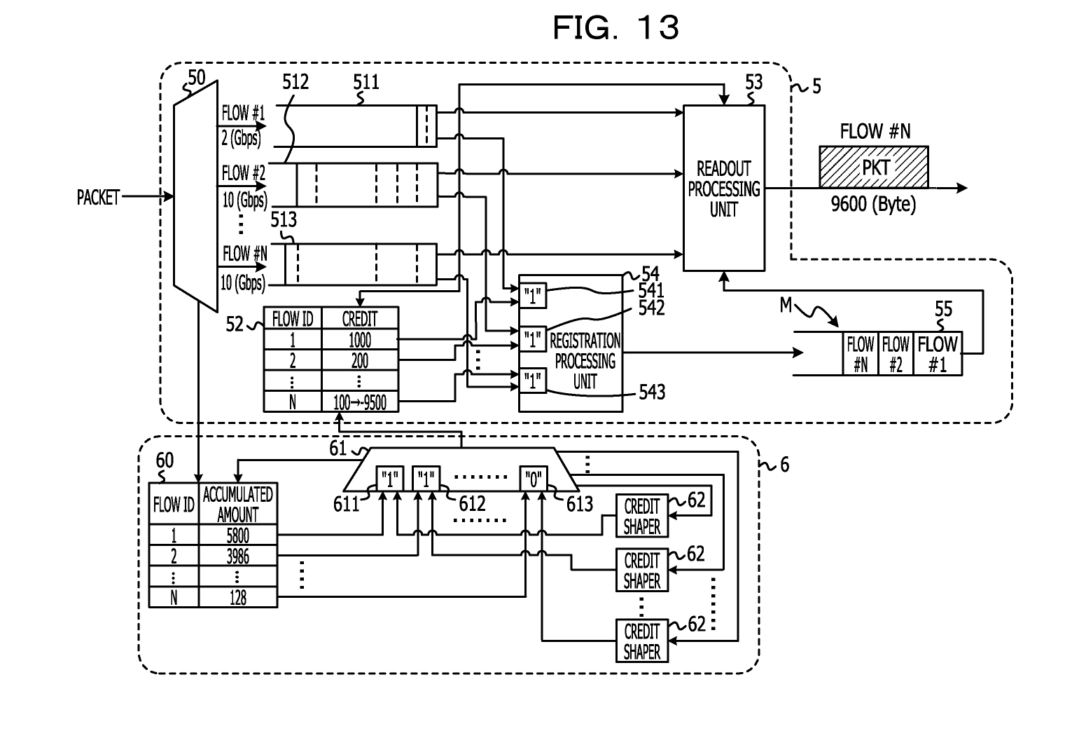

FIG. 13 illustrates an example of a state after packet readout in a case where an input rate of a flow is different. In the present example, the input rate of the flow #1 is 2 (Gbps), and the flow #1 is, for example, a bandwidth-guaranteed real-time/interactive traffic such as audio data or finance system data. In addition, the input rates of the flow #2 and the flow #N are 10 (Gbps), and each of the flow #2 and the flow #N is, for example, a best effort traffic.

After being read out from the queues 511 to 513, the packets of the flows #1, #2, and #N are transmitted from an output port having the bandwidth of, for example, 10 (Gbps) to another device. Therefore, the credit shapers 62 of the flows #1, #2, and #N perform bandwidth control so that the sum of the output rates of the flows #1, #2, and #N becomes 10 (Gbps)).

The credit shaper 62 of the flow #1 adjusts a time interval for payout of a credit so that the readout rate of packets of the flow #1, in other words, an output rate, becomes 2 (Gbps). In addition, the credit shapers 62 of the flow #2 and the flow #N adjust time intervals for payout of credits performed by the credit payout unit 61 so that the respective output rates of packets of the flow #2 and the flow #N become 4 (Gbps).

However, since it is difficult for the readout processing unit 53 to divide and read out one packet, the readout processing unit 53 reads out a packet whose data amount exceeds the credit counter. In a case where, for example, a packet (jumbo frame) of 9600 (Byte) is accumulated in the queue 513 of the flow #N, the readout processing unit 53 reads out the relevant packet even if the credit counter of the relevant queue is 100 (Byte). At this time, the credit counter after readout becomes −9500 (Byte) (=100 (Byte)−9600 (Byte)).

In this way, even if the scheduler unit 6 performs bandwidth control using the credit shapers 62, the readout processing unit 53 reads out a packet while permitting a credit to be put into a debt status. Therefore, an excessive burst traffic exceeding a controlled output rate occurs. This burst traffic influences the traffic of the bandwidth-guaranteed flow #1 in an output port.

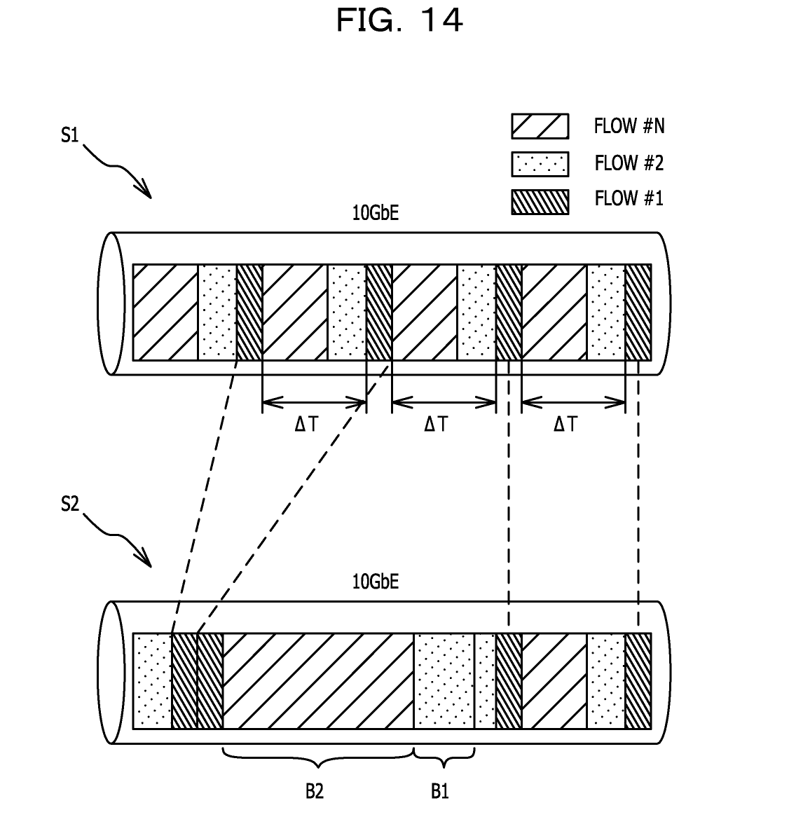

FIG. 14 illustrates an occupancy state of a bandwidth of each of the flows #1, #2, and #N in an output port. Here, a symbol S1 indicates an occupancy state of a bandwidth of an ideal traffic, and a symbol S2 indicates an occupancy state of a bandwidth when burst traffics occur in the flows #2 and #N. In addition, it is assumed that the bandwidth of the output port is 10 (Gbps) (in other words, “10 GbE”).

In a case of the ideal traffic, the packets of the bandwidth-guaranteed flow #1 are practically output at a certain interval ΔT. On the other hand, in a case where burst traffics occur in the flows #2 and #N, packets of the flows #2 and #N occupy large bandwidths B1 and B2 prior to a packet of the flow #1. Therefore, a delay on a millisecond time scale occurs in the packet of the flow #1.

Accordingly, in a case where, in such a manner as in a best effort traffic, the bandwidth is not controlled and the number of flows input at rates exceeding bandwidths the shapers 62 control is large, a debt status frequently occurs, and hence, the bandwidth of the output port is squeezed. Therefore, there is a problem that a delay or a fluctuation on a millisecond time scale occurs in a packet of a flow bandwidth-guaranteed in such a manner as in, for example, the audio system data or the finance system data and communication quality is deteriorated.

In contrast to this, if readout control of packets is performed without permitting the debt status, it is possible to avoid the delay or fluctuation of a packet.

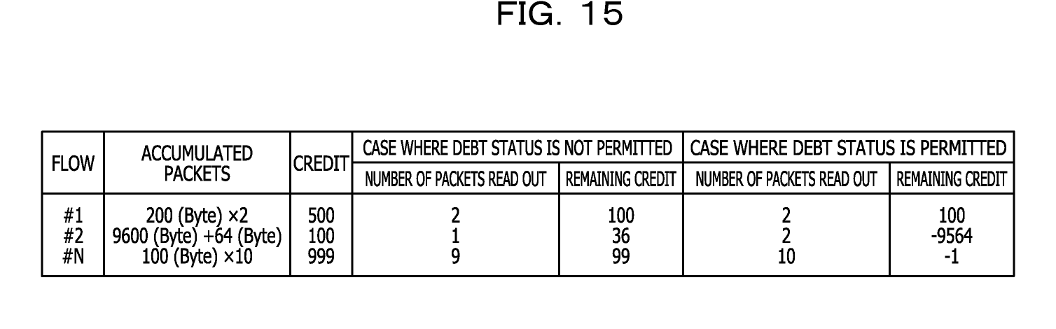

FIG. 15 illustrates the number of packets and a credit in each of a case where a debt status is not permitted and a case where a debt status is permitted. Before readout of packets, two packets each containing 200 (Byte) are accumulated in the queue 511 of the flow #1, and the credit counter of the flow #1 indicates 500 (Byte). In addition, a packet of 9600 (Byte) and a packet of 64 (Byte) are accumulated in the queue 512 of the flow #2, and the credit counter of the flow #2 indicates 100 (Byte). 10 packets each containing 100 (Byte) are accumulated in the queue 513 of the flow #N, and the credit counter of the flow #N indicates 999 (Byte).

The credit of the flow #1 is larger than the sum of the data amounts of accumulated packets. Therefore, as for the flow #1, regardless of whether or not to permit a debt status, two packets are read out, and a credit of 100 (Byte) remains.

The credit of the flow #2 is smaller than the sum of the data amounts of accumulated packets. Therefore, as for the flow #2, in a case of not permitting a debt status, a packet of 64 (Byte) is only read out, and a credit of 36 (Byte) remains. On the other hand, in a case of permitting a debt status, a packet of 9600 (Byte) and a packet of 64 (Byte) are read out, and a credit of −9564 (Byte) remains.

The credit of the flow #N is smaller than the sum of the data amounts of accumulated packets. Therefore, as for the flow #N, in a case of not permitting a debt status, nine packets each containing 100 (Byte) are only read out, and a credit of 99 (Byte) remains. On the other hand, in a case of permitting a debt status, ten packets each containing 100 (Byte) are read out, and a credit of −1 (Byte) remains.

In a case of reading out packets so as not to permit a debt status, it is desirable to determine, at each timing of readout, which packet out of packets accumulated in the queues 511 to 513 is able to be read out. Since excessive burdens are imposed on hardware, such processing is difficult in practice.

In addition, if determination is limited to a leading packet, in other words, a packet earliest accumulated, from among packets accumulated in the queues 511 to 513, and it is determined whether or not a debt status occurs at the time of readout of the relevant packet, a processing load is reduced. However, in this case, since one packet is only read out at each timing of readout, another problem that a throughput is reduced occurs. Accordingly, a method for reading out packets as a burst traffic while consuming as much as possible a credit so as not to leave the credit is desirable.

### First Embodiment

Therefore, in a communication device according to an embodiment, a queue to which a packet is input at an input rate less than or equal to a readout rate based on an assigned credit is prioritized from among a plurality of queues, credits are consumed in order of satisfying the above-mentioned readout condition, and hence, communication quality is improved.

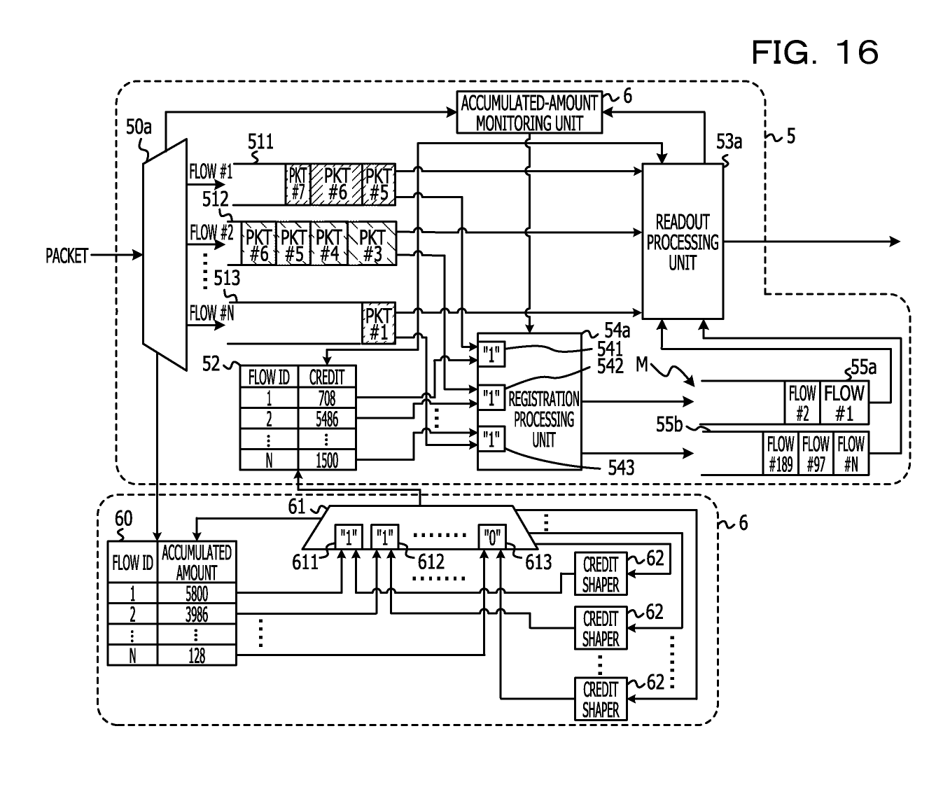

FIG. 16 is a configuration diagram illustrating the functional configuration of an output processing unit 913 in a first embodiment. In FIG. 16, the same symbol is assigned to a configuration in common with FIG. 7, and the description thereof will be omitted.

The output processing unit 913 includes the queue management unit 5 and the scheduler unit 6. The queue management unit 5 includes a distribution unit 50a, the plural queues 511 to 513, the credit counter unit 52, a readout processing unit 53a, a registration processing unit 54a, an accumulated-amount monitoring unit 56, and a memory (storage unit) M. The memory M stores therein a first readout order registration list 55a and a second readout order registration list 55b in which identifiers of the queues 511 to 513 serving as readout targets of the readout processing unit 53a, in other words, flow IDs, are registered.

The scheduler unit 6 includes the accumulated-amount counter unit 60, the credit payout unit 61, and the plural credit shapers 62. In addition, the operation of the scheduler unit 6 is as described with reference to FIG. 4.

Based on notifications from the distribution unit 50a and the readout processing unit 53a, the accumulated-amount monitoring unit 56 counts and monitors the sum of the data amounts of packets accumulated in each of the queues 511 to 513 of the flows #1 to #N. The accumulated-amount monitoring unit 56 counts not such a virtually accumulated amount as an accumulated-amount counter the accumulated-amount counter unit 60 counts but the sum of the data amounts of packets actually accumulated in each of the queues 511 to 513.

The distribution unit 50a not only distributes input packets to the plural queues 511 to 513, based on flow IDs, but also notifies the accumulated-amount monitoring unit 56 of the data amounts (lengths) of packets input to each of the queues 511 to 513. In addition, the readout processing unit 53a acquires a flow ID from the first readout order registration list 55a or the second readout order registration list 55b, and reads out a packet from one of the queues 511 to 513 that corresponds to the relevant flow ID by consuming a credit. At this time, the readout processing unit 53a notifies the accumulated-amount monitoring unit 56 of the data amounts (lengths) of packets read out from each of the queues 511 to 513.

By adding the data amounts given notice of by the distribution unit 50a and subtracting the data amounts given notice of by the readout processing unit 53a, the accumulated-amount monitoring unit 56 counts the accumulated amount of packets of each of the flows #1 to #N. The accumulated-amount monitoring unit 56 notifies the registration processing unit 54a of the accumulated amount of packets of each of the flows #1 to #N.

The registration processing unit 54a determines whether or not one of the queues 511 to 513 satisfies the readout condition, and registers the flow ID of the one queue of the queues 511 to 513 satisfying the readout condition, in one of the first readout order registration list 55a and the second readout order registration list 55b in order of satisfying the readout condition. The registration processing unit 54a includes the readout flags 541 to 543 for the queues 511 to 513, respectively. The contents of the readout flags 541 to 543 are the same as those of the readout flags 41 to 43 described with reference to FIG. 4, and the readout condition is as described above.

The first readout order registration list 55a is treated as a priority list in which the flow ID of a prioritized flow is registered, and the second readout order registration list 55b is treated as a non-priority list in which the flow ID of a non-prioritized flow is registered. In addition, in the following description, the first readout order registration list 55a and the second readout order registration list 55b are expressed by a “priority list” and a “non-priority list”, respectively.

Based on the accumulated amounts of packets of the respective flows #1 to #N, given notice by the accumulated-amount monitoring unit 56, the registration processing unit (judgment unit) 54a judges which of the priority list 55a and the non-priority list 55b each flow ID is to be registered in. From among the plural queues 511 to 513, the registration processing unit 54a judges, as a prioritized queue, a queue to which packets are input at a rate less than or equal to a readout rate based on a credit assigned by the scheduler unit 6. In addition, the registration processing unit 54a registers, in the priority list 55a, a flow ID corresponding to the prioritized queue, and registers, in the non-priority list 55b, a flow ID corresponding to another queue (non-prioritized queue).

From among the plural queues 511 to 513, the readout processing unit 53a prioritizes the above-mentioned prioritized queue, and reads out one or more packets by consuming a credit in order of satisfying the readout conditions for individual queues. In other words, the readout processing unit 53a acquires a flow ID while prioritizing the priority list 55a over the non-priority list 55b, and reads out one or more packets from a queue corresponding to the acquired flow ID among the plural queues 511 to 513. Since, in this way, the registration processing unit 54a registers flow IDs while categorizing the flow IDs into the priority list 55a and the non-priority list 55b, it is possible for the readout processing unit 53a to easily determine the priority of a packet (in other words, a flow).

More specifically, from among the plural queues 511 to 513, the registration processing unit 54a judges, as a prioritized queue, a queue satisfying a priority condition that a held credit is greater than or equal to an amount corresponding to the sum of the data amounts of accumulated packets. In the present embodiment, since a credit of 1 (Byte) corresponds to the data amount of a packet of 1 (Byte), the above-mentioned priority condition is “a credit the sum of the data amounts of accumulated packets”. In other words, as for a queue satisfying the priority condition of “a credit≧the sum of the data amounts of accumulated packets” among the plural queues 511 to 513, the corresponding flow ID is registered in the priority list 55a. In other words, as for a queue satisfying the priority condition of “a credit<the sum of the data amounts of accumulated packets” among the plural queues 511 to 513, the corresponding flow ID is registered in the non-priority list 55b.

In the same way as the second comparative example, at the time of the occurrence of each of the events of storage of a packet, payout of a credit, and readout of a packet, the registration processing unit 54a registers a flow ID in one of the priority list 55a and the non-priority list 55b. Hereinafter, the registration processing of the registration processing unit 54a will be described.

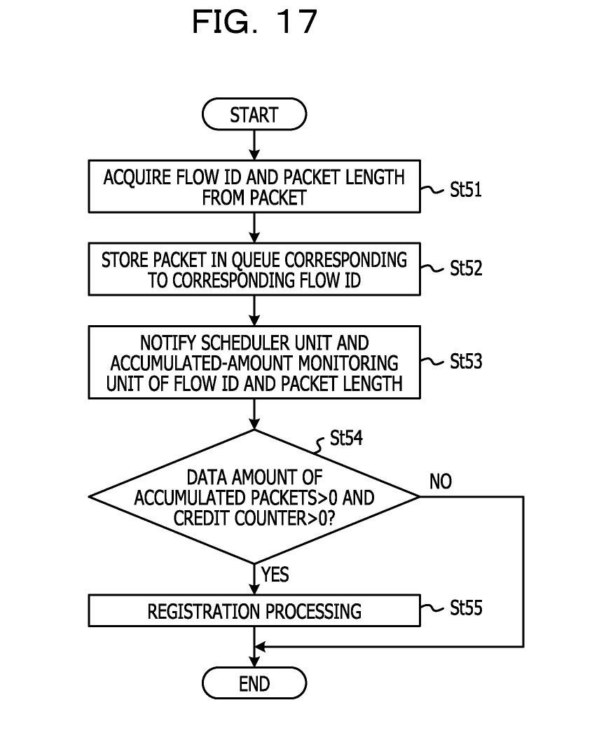

FIG. 17 is a flowchart illustrating an example of the operation of the queue management unit 5 when storing a packet in one of the queues 511 to 513. First, the distribution unit 50a acquires a flow ID and a packet length from a packet input from the switch card 92 (step St51).

Next, the distribution unit 50a stores the packet in one of the queues 511 to 513 that corresponds to the acquired flow ID (step St52). Next, the distribution unit 50a notifies the scheduler unit 6 and the accumulated-amount monitoring unit 56 of the acquired flow ID and packet length (step St53). Next, the registration processing unit 54a determines whether a readout condition that the data amount of packets accumulated in the one queue of the queues 511 to 513 that corresponds to the relevant flow ID is greater than zero and a credit counter corresponding to the relevant flow ID is greater than zero is satisfied or not (step St54).

In a case where the readout condition is not satisfied (step St54: No), the queue management unit 5 terminates the processing. On the other hand, in a case where the readout condition is satisfied (step St54: Yes), the registration processing unit 54a performs registration processing for the flow ID (step St55). In this way, the queue management unit 5 performs the processing when a packet is stored. In addition, the registration processing for the flow ID will be described later.

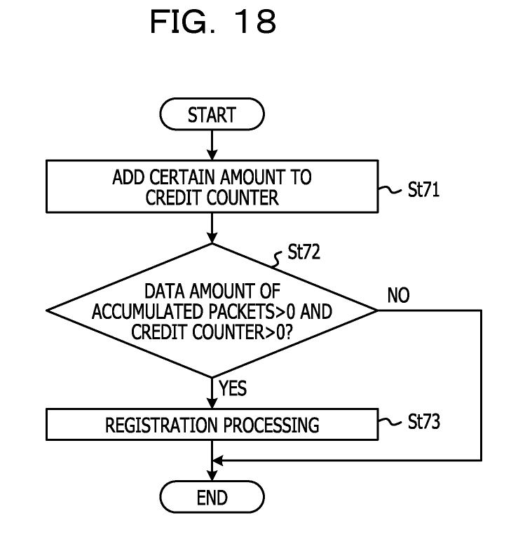

FIG. 18 is a flowchart illustrating an example of the operation of the queue management unit when a credit is paid out. First, the credit counter unit 52 adds a certain amount of credit paid out from the scheduler unit 6, to the credit counter of a corresponding flow ID (step St71).

Next, the registration processing unit 54a determines whether the readout condition that the data amount of packets accumulated in the one queue of the queues 511 to 513 that corresponds to the relevant flow ID is greater than zero and a credit counter corresponding to the relevant flow ID is greater than zero is satisfied or not (step St72). In a case where the readout condition is not satisfied (step St72: No), the queue management unit 5 terminates the processing.

On the other hand, in a case where the readout condition is satisfied (step St72: Yes), the registration processing unit 54a performs the registration processing (step St73), and the queue management unit 5 terminates the processing. In this way, the queue management unit 5 performs the processing when a credit is paid out.

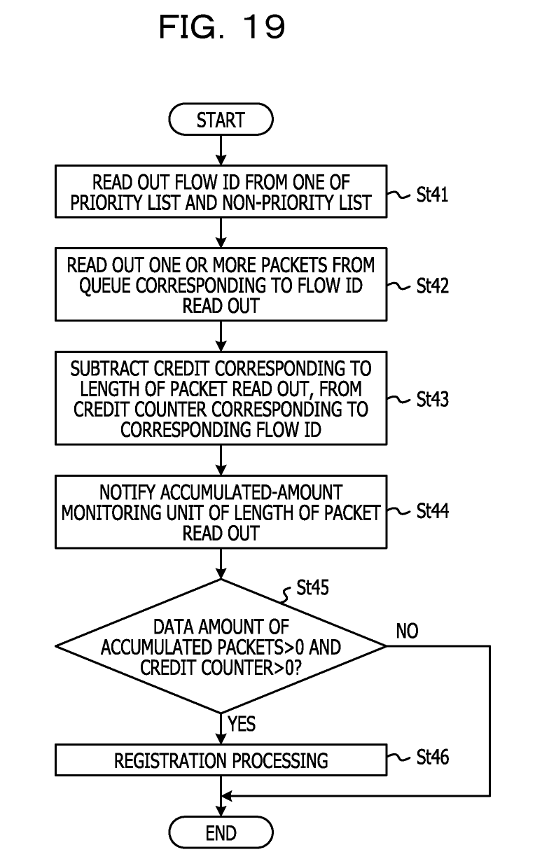

In addition, FIG. 19 is a flowchart illustrating an example of the operation of the queue management unit 5 when reading out a packet. First, the readout processing unit 53a reads out a leading flow ID from one of the priority list 55a and the non-priority list 55b (step St41). At this time, the readout processing unit 53a reads out a flow ID while prioritizing the priority list 55a over the non-priority list 55b. The flow ID read out is deleted from the priority list 55a or the non-priority list 55b.

Next, the readout processing unit 53a reads out one or more packets from one of the queues 511 to 513 that corresponds to the flow ID read out (step St42). Next, the readout processing unit 53a subtracts a credit corresponding to the length of the packet read out, from a credit counter corresponding to the relevant flow ID (step St43). In other words, the readout processing unit 53a prioritizes a prioritized queue, and reads out, by consuming credits, packets from the plural queues 511 to 513 in order of satisfying the readout conditions relating to credits of individual queues and the data amounts of packets accumulated in individual queues.

Next, the readout processing unit 53a notifies the accumulated-amount monitoring unit 56 of the length of the packet read out, in other words, a data amount (step St44). In addition, any one of the individual processing operations in the step St43 and the step St44 may be performed first.

Next, the registration processing unit 54a determines whether the readout condition that the data amount of packets accumulated in the one queue of the queues 511 to 513 that corresponds to the relevant flow ID is greater than zero and a credit counter of the relevant flow ID is greater than zero is satisfied or not (step St45). In a case where the readout condition is not satisfied (step St45: No), the queue management unit 5 terminates the processing.

On the other hand, in a case where the readout condition is satisfied (step St45: Yes), the registration processing unit 54a performs the registration processing (step St46), and the queue management unit 5 terminates the processing. In this way, the queue management unit 5 performs the processing at the time of reading out a packet.

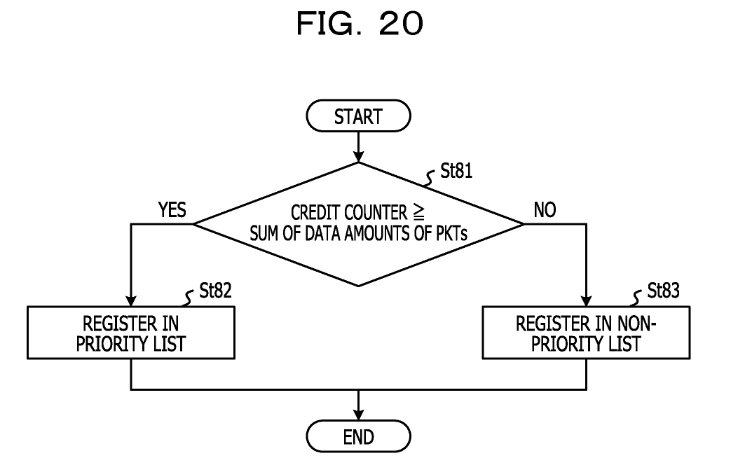

Next, the registration processing (step St55, St73, or St46) in each of the above-mentioned operations will be described. FIG. 20 is a flowchart of the registration processing in the first embodiment.

First, the registration processing unit 54a determines whether or not one of the queues 511 to 513 that corresponds to the corresponding flow ID satisfies “a credit counter the sum of the data amounts of packets” (the priority condition) (step St81). At this time, the registration processing unit 54a acquires the credit counter from the credit counter unit 52, and acquires the sum of the data amounts of packets, in other words, the accumulated amount of packets, from the accumulated-amount monitoring unit 56.

In a case where the priority condition is satisfied (step St81: Yes), the registration processing unit 54a registers the corresponding flow ID in the priority list 55a (step St82), and terminates the processing. On the other hand, in a case where the priority condition is not satisfied (step St81: No), the registration processing unit 54a registers the corresponding flow ID in the non-priority list 55b (step St83), and terminates the processing. In this way, the registration processing is performed.

In this way, in the present embodiment, the registration processing unit 54a judges a queue satisfying the priority condition among the plural queues 511 to 513, and registers flow IDs while categorizing the flow IDs into the priority list 55a and the non-priority list 55b. Accordingly, one of the queues 511 to 513 that is free from the possibility that a credit is put into a debt status is determined as a prioritized queue, and the corresponding flow ID is registered in the priority list 55a. By contraries, one of the queues 511 to 513 having the possibility that a credit is put into a debt status is determined as a non-prioritized queue, and the corresponding flow ID is registered in the non-priority list 55b.

From among the plural queues 511 to 513, the readout processing unit 53a prioritizes the prioritized queue, and reads out a packet by consuming a credit in order of satisfying the readout condition. Therefore, readout of a packet from one of the queues 511 to 513 having the possibility that a credit is put into a debt status is performed after one of the queues 511 to 513 that is free from the possibility that a credit is put into a debt status.

Accordingly, in the readout processing for packets, among the plural queues 511 to 513, a queue to which packets are input at a rate less than or equal to a readout rate based on a credit assigned by the scheduler unit 6 is prioritized over other queues. Therefore, there is lessened a possibility that a debt status frequently occurs and hence a delay or a fluctuation occurs in a packet of a specific flow.

In addition, while, in the present embodiment, based on the above-mentioned priority condition, from among the plural queues 511 to 513, the registration processing unit 54a judges a queue to which packets are input at a rate less than or equal to a readout rate based on a credit assigned by the scheduler unit 6, the registration processing unit 54a is not limited to this. The registration processing unit 54a may include, for example, a measuring unit that individually measures input rates when packets are input to the queues 511 to 513 and output rates when packets are read out from the queues 511 to 513, and judge a prioritized queue in accordance with the corresponding measurement result.

### Second Embodiment

Whether or not the priority condition is satisfied may change according to the occurrence of one of events of storage of a packet, payout of a credit, and readout of a packet. Accordingly, the registration of a flow ID may be dynamically changed between the priority list 55a and the non-priority list 55b with the occurrence of an event serving as a trigger of the registration of a flow ID. In this case, in order to manage a registration state based on the priority (prioritized or non-prioritized) of each flow ID, the registration processing unit 54a may hold a registration management table.

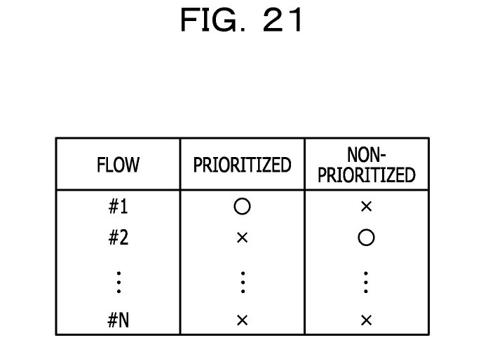

FIG. 21 illustrates an example of the registration management table in a second embodiment. In FIG. 21, a circle (see “0”) indicates that the relevant flow ID is registered, and an x-mark (see “x”) indicates that the relevant flow ID is not registered.

In the present example, the flow #1 is registered in the priority list 55a, and the flow #2 is registered in the non-priority list 55b. In addition, the flow #N is not registered in the priority list 55a or the non-priority list 55b. This state of being unregistered occurs in, for example, a case where the credit counter of the flow #N is a negative value or in a case where the queue 513 is empty.

The registration processing unit 54a manages the registration state so that the registration destinations of each flow ID become one point at a maximum. In other words, the registration processing unit 54a avoids the double registration of each flow ID. By referencing the registration management table, the registration processing unit 54a determines whether or not it is desirable to change a flow ID.

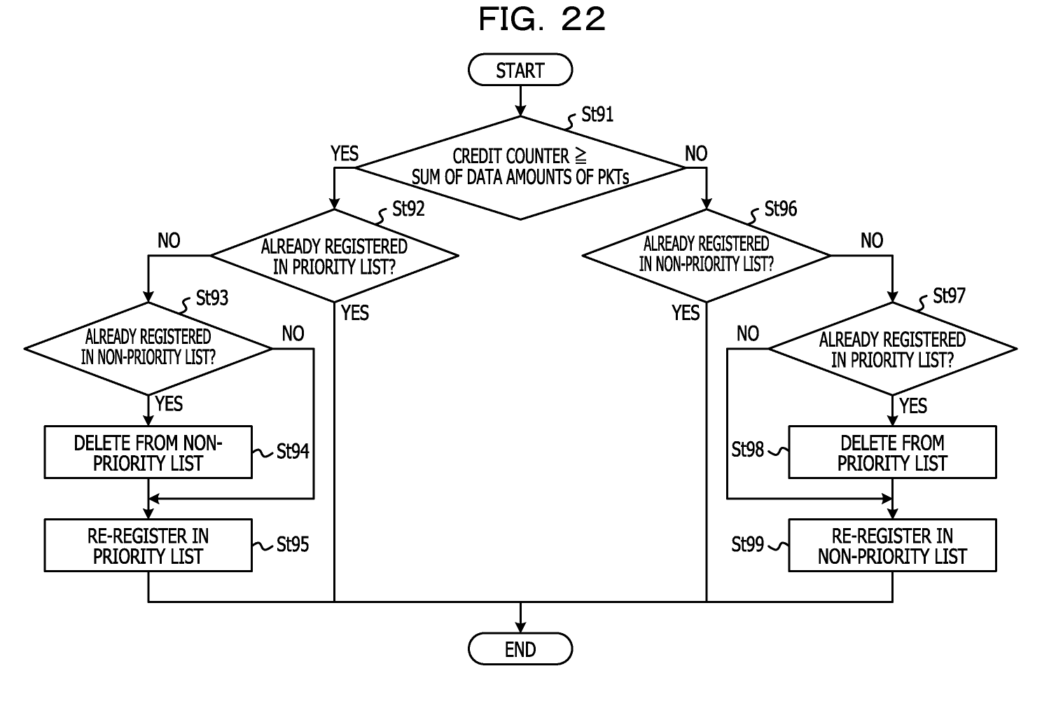

FIG. 22 is a flowchart of registration processing in the second embodiment. First, the registration processing unit 54a determines whether or not one of the queues 511 to 513 that corresponds to the corresponding flow ID satisfies “a credit counter the sum of the data amounts of packets” (the priority condition) (step St91).

In a case where the priority condition is satisfied (step St91: Yes), the registration processing unit 54a references the registration management table, and determines whether or not the corresponding flow ID has already been registered in the priority list 55a (step St92). In a case where the corresponding flow ID has already been registered in the priority list 55a (step St92: Yes), the registration processing unit 54a terminates the processing.

On the other hand, in a case where the corresponding flow ID has not already been registered in the priority list 55a (step St92: No), the registration processing unit 54a references the registration management table, and determines whether or not the corresponding flow ID has already been registered in the non-priority list 55b (step St93). In a case where the corresponding flow ID has already been registered in the non-priority list 55b (step St93: Yes), the registration processing unit 54a deletes the corresponding flow ID from the non-priority list 55b (step St94).

Next, the registration processing unit 54a re-registers the corresponding flow ID in the priority list 55a (step St95), and terminates the processing. In a case where the corresponding flow ID has not already been registered in the non-priority list 55b (step St93: No), this processing is performed in the same way. At this time, the registration processing unit 54a updates the registration management table in accordance with the change of registration.

On the other hand, in a case where the priority condition is not satisfied (step St91: No), the registration processing unit 54a references the registration management table, and determines whether or not the corresponding flow ID has already been registered in the non-priority list 55b (step St96). In a case where the corresponding flow ID has already been registered in the non-priority list 55b (step St96: Yes), the registration processing unit 54a terminates the processing.

On the other hand, in a case where the corresponding flow ID has not already been registered in the non-priority list 55b (step St96: No), the registration processing unit 54a references the registration management table, and determines whether or not the corresponding flow ID has already been registered in the priority list 55a (step St97). In a case where the corresponding flow ID has already been registered in the priority list 55a (step St97: Yes), the registration processing unit 54a deletes the corresponding flow ID from the priority list 55a (step St98).

Next, the registration processing unit 54a re-registers the corresponding flow ID in the non-priority list 55b (step St99), and terminates the processing. In a case where the corresponding flow ID has not already been registered in the priority list 55a (step St97: No), this processing is performed in the same way. At this time, the registration processing unit 54a updates the registration management table in accordance with the change of registration. In this way, the registration processing is performed.

In this way, when the scheduler unit 6 assigns a credit to a queue, whose flow ID (identifier) is registered in the non-priority list 55b, among the plural queues 511 to 513, the registration processing unit 54a determines whether or not the corresponding queue satisfies the priority condition. In addition, in a case where the corresponding queue satisfies the priority condition, the registration processing unit 54a re-registers the corresponding flow ID in the priority list 55a.

In addition, when the readout processing unit 53a reads out one or more packets from a queue, whose flow ID (identifier) is registered in the priority list 55a, among the plural queues 511 to 513, the registration processing unit 54a determines whether or not the corresponding queue satisfies the priority condition. In addition, in a case where the corresponding queue does not satisfy the priority condition, the registration processing unit 54a re-registers the corresponding flow ID in the non-priority list 55b.

Furthermore, when one or more packets are accumulated in a queue, whose flow ID (identifier) is registered in the priority list 55a, among the plural queues 511 to 513, the registration processing unit 54a determines whether or not the corresponding queue satisfies the priority condition. In addition, in a case where the corresponding queue does not satisfy the priority condition, the registration processing unit 54a re-registers the corresponding flow ID in the non-priority list 55b.

Accordingly, the registration of the flow ID is dynamically changed in accordance with the priority condition. Therefore, even in a case where a bursty traffic is input (for example, inputting of a long packet), it is possible for the readout processing unit 53a to flexibly control the priority of the readout processing for each of the queues 511 to 513.

In addition, when re-registering a flow ID, the registration processing unit 54a deletes the flow ID from the priority list 55a or the non-priority list 55b, in which the flow ID has been registered before the relevant re-registration. When it is assumed that the flow ID is not deleted, in a case where the flow #1 is re-registered, for example, in the priority list 55a from the non-priority list 55b, the readout processing unit 53a reads out a packet from the queue 511 in accordance with the flow #1 acquired from the priority list 55a and the non-priority list 55b. In other words, the readout processing unit 53a performs the processing for reading out a packet from the queue 511 of the flow #1 twice in accordance with both the priority list 55a and the non-priority list 55b.

Accordingly, in a case where the queue 511 becomes empty according to the first readout processing, the readout processing unit 53a turns out to wastefully read out no packet of the queue 511 in the second readout processing. Accordingly, by deleting the flow ID from the former list 55a or 55b at the time of changing the registration of the flow ID, reading out no packet of the queues 511 to 513 is avoided, and the efficiency of the readout processing is improved.

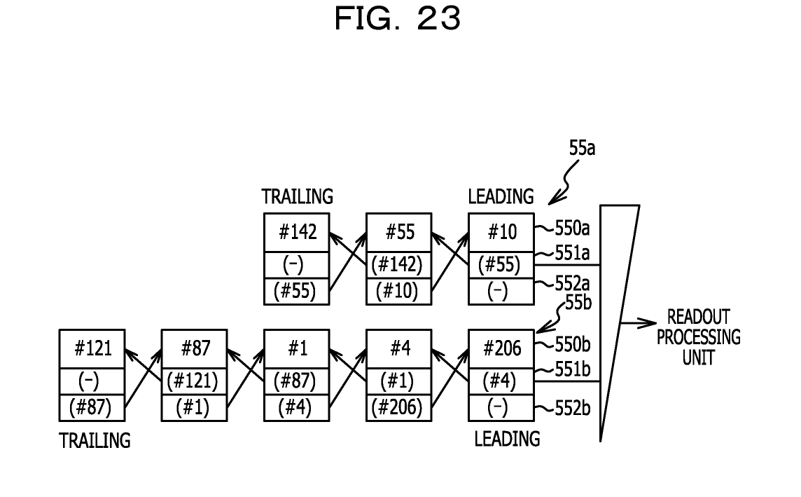

In order to make it easy to change the registration of the flow ID as described above, it is desirable that the priority list 55a and the non-priority list 55b are each configured using, for example, a bi-directional link list. FIG. 23 is a configuration diagram illustrating examples of the configurations of the priority list 55a and the non-priority list 55b in this case.

In the priority list 55a, a leading flow #10 (see “leading”) is a flow earliest registered among registered flow IDs 550a, and a trailing flow #142 (see “trailing”) is a flow last registered among the registered flow IDs 550a. In the non-priority list 55b, a leading flow #206 is a flow earliest registered among registered flow IDs 550b, and a trailing flow #121 is a flow last registered among the registered flow IDs 550b.

The priority list 55a includes one or more groups of the flow ID 550a, a backward link pointer 551a, and a forward link pointer 552a. In FIG. 23, flow IDs the backward link pointer 551a and the forward link pointer 552a indicate are indicated in parentheses. As for flow IDs, the backward link pointer 551a indicates a first flow ID 550a on a rear side (trailing side) of a second flow ID 550a, and the forward link pointer 552a indicates a first flow ID 550a on a front side (leading side) of a second flow ID 550a.

Since, for example, the backward link pointer 551a of a flow #55 is “#142”, a flow ID on a rear side of the flow #55 is “#142”. In addition, since the forward link pointer 552a of the flow #55 is “#10”, a flow ID on a front side of the flow #55 is “#10”. In addition, since the forward link pointer 552a of the leading flow ID 550a or the backward link pointer 551a of the trailing flow ID 550a does not exist, “-” is described in the forward link pointer 552a of the leading flow ID 550a and the backward link pointer 551a of the trailing flow ID 550a.

The non-priority list 55b includes one or more groups of the flow ID 550b, a backward link pointer 551b, and a forward link pointer 552b. In FIG. 23, flow IDs the backward link pointer 551b and the forward link pointer 552b indicate are indicated in parentheses. The backward link pointer 551b indicates a first flow ID 550b on a rear side (trailing side) of a second flow ID 550b, and the forward link pointer 552b indicates a first flow ID 550b on a front side (leading side) of a second flow ID 550b.

Since, for example, the backward link pointer 551b of the flow #1 is “#87”, a flow ID on a rear side of the flow #1 is “#87”. In addition, since the forward link pointer 552b of the flow #1 is “#4”, a flow ID on a front side of the flow #1 is “#4”. In addition, since the forward link pointer 552b of the leading flow ID 550b or the backward link pointer 551b of the trailing flow ID 550b does not exist, “-” is described in the forward link pointer 552b of the leading flow ID 550b and the backward link pointer 551b of the trailing flow ID 550b.

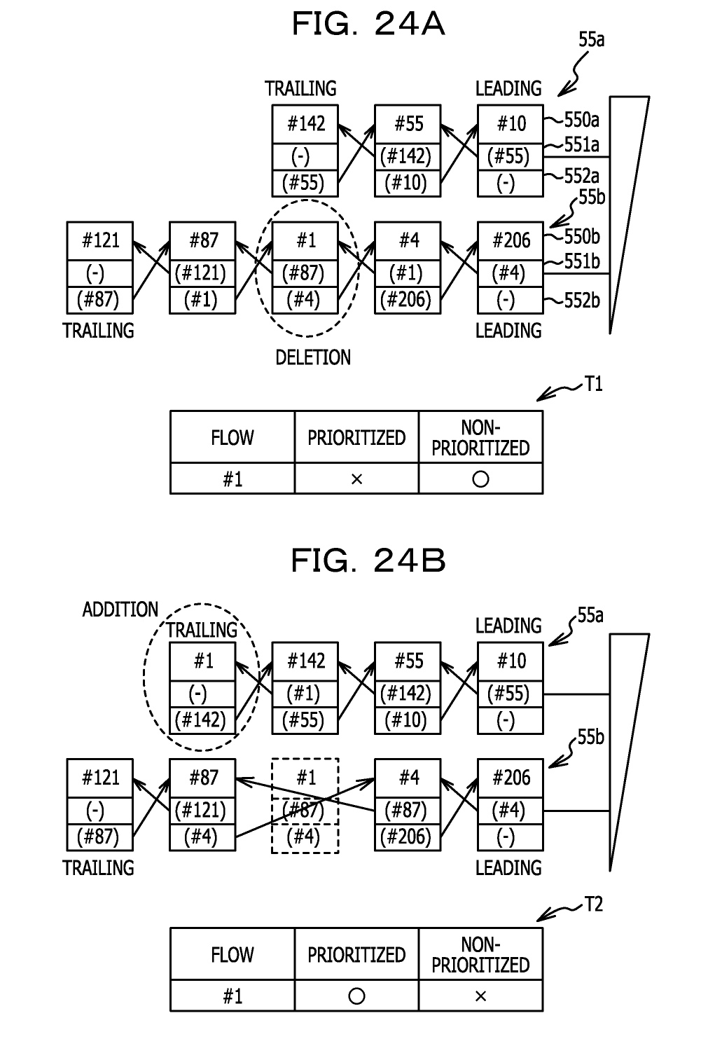

Next, an example of a change of registration utilizing this bi-directional link list will be described. FIGS. 24A and 24B are configuration diagrams illustrating examples of states of the priority list 55a and the non-priority list 55b before and after a change of registration. FIG. 24A illustrates states of the priority list 55a and the non-priority list 55b and a registration management table T1 of the flow #1 before a change of registration. In addition, FIG. 24B illustrates states of the priority list 55a and the non-priority list 55b and a registration management table T2 of the flow #1 after a change of registration. As will be understood by referencing the registration management tables T1 and T2, here an example in which the registration destination of the flow #1 is changed from the non-priority list 55b to the priority list 55a will be described.

The flow #1 is deleted from the non-priority list 55b (see “deletion”), and added to the end of the priority list 55a (see “addition”). At this time, in the priority list 55a, the backward link pointer 551a of the flow #142, registered at the end, is changed from “-” (unregistered) to “#1”. In addition, the backward link pointer 551a of the flow #1 is “-” (unregistered), and the forward link pointer 552a of the flow #1 is “#142”. From this, the flow #1 is linked to rearward of the flow #142.

In addition, in the non-priority list 55b, since the flow #1 is deleted, the backward link pointer 551b of the flow #4, registered at the front of the flow #1, is changed from “#1” to “#87”. In addition, the forward link pointer 552b of the flow #87, registered at the rear of the flow #1, is changed from “#1” to “#4”. From this, the flow #87 is linked to rearward of the flow #4.

In this way, the bi-directional link list is used, and hence, it is possible to easily change the registration of the flow ID only by changing the forward link pointers 552a and 552b and the backward link pointers 551a and 551b. In addition, using the bi-directional link list, the burden of the search processing for the flow ID serving as a target of registration changing is reduced.

### Third Embodiment

In a case where, in one of the embodiments described above, the input rate and the output rate of a flow are close to each other, it is likely that whether or not the priority condition is satisfied is repeated and the registration changing of the corresponding flow ID is frequently repeated between the priority list 55a and the non-priority list 55b. For example, in a case where the output rate of the flow #1, controlled by the corresponding credit shaper 62, is 10 (Gbps) while the input rate of the flow #1 is 11 (Gbps), the flow #1 is alternately registered in the priority list 55a and the non-priority list 55b. If such a situation occurs, it is likely that the output rate is unstable and communication quality is deteriorated.

Therefore, regardless of the above-mentioned priority condition, the registration processing unit 54a may judge, as a prioritized queue, a queue out of the plural queues 511 to 513, the queue holding a credit greater than or equal to a predetermined amount. From this, regardless of whether or not the priority condition is satisfied, a flow ID corresponding to the one queue out of the queues 511 to 513, the queue holding a credit greater than or equal to the predetermined amount, is registered in the priority list 55a.

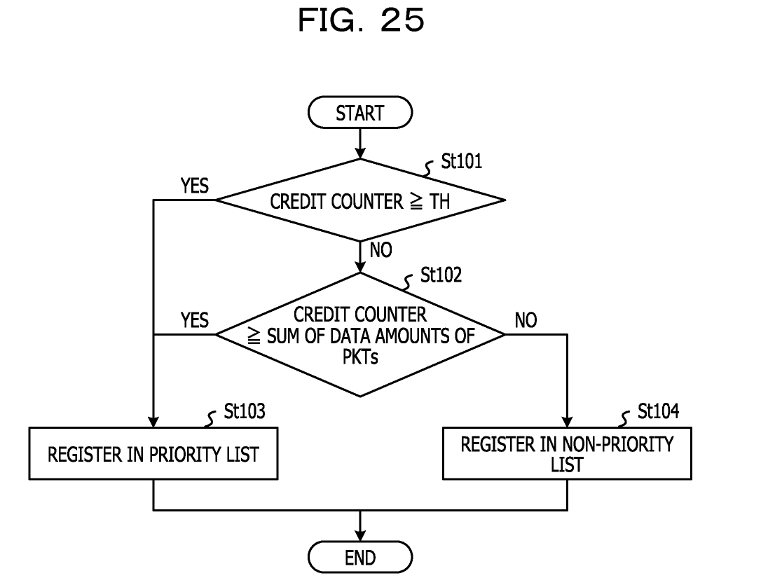

FIG. 25 is a flowchart of registration processing in a third embodiment. First, the registration processing unit 54a determines whether or not the credit counter of the corresponding flow ID is greater than or equal to a predetermined amount TH (step St101). At this time, the registration processing unit 54a acquires the credit counter from the credit counter unit 52.

In a case where the credit counter of the corresponding flow ID is greater than or equal to the predetermined amount TH (step St101: Yes), the registration processing unit 54a registers the corresponding flow ID in the priority list 55a (step St103), and terminates the processing. On the other hand, in a case where the credit counter of the corresponding flow ID is smaller than the predetermined amount TH (step St101: No), the registration processing unit 54a determines whether or not one of the queues 511 to 513 that corresponds to the corresponding flow ID satisfies “a credit counter the sum of the data amounts of packets” (the priority condition) (step St102). At this time, the registration processing unit 54a acquires the credit counter from the credit counter unit 52, and acquires the sum of the data amounts of packets, in other words, the accumulated amount of packets, from the accumulated-amount monitoring unit 56.

In a case where the priority condition is satisfied (step St102: Yes), the registration processing unit 54a registers the corresponding flow ID in the priority list 55a (step St103), and terminates the processing. On the other hand, in a case where the priority condition is not satisfied (step St102: No), the registration processing unit 54a registers the corresponding flow ID in the non-priority list 55b (step St104), and terminates the processing. In this way, the registration processing is performed. In addition, while the processing illustrated in FIG. 25 is obtained by adding the processing operation in the step St101 to the processing illustrated in FIG. 20, the processing operation in the step St101 may be added to the processing illustrated in FIG. 22.

In this way, regardless of the priority condition, the registration processing unit 54a judges, as a prioritized queue, one queue out of the queues 511 to 513, the queue holding a credit greater than or equal to the predetermined amount TH, and hence, the output rate of the corresponding flow becomes stable.

### Fourth Embodiment

While, in one of the embodiments described above, the registration processing unit 54a categorizes flow IDs into the two lists 55a and 55b and registers the flow IDs, the flow IDs are not limited to this, and may be categorized into, for example, four lists and registered. In this case, a priority may be determined in accordance with input rates at the time of the occurrences of, for example, the above-mentioned three events (storage of a packet, payout of a credit, and readout of a packet), and may be categorized into first to fourth lists and registered.

For example, in a case where the above-mentioned priority condition is satisfied when a credit is paid out from the scheduler unit 6, it is considered that the input rate of a packet is relatively high. In addition, in a case where the priority condition is satisfied when a packet is stored in one of the queues 511 to 513 or when a packet is read out from one of the queues 511 to 513, it is considered that the input rate of a packet is relatively low. Therefore, priorities 1 to 4 may be defined in accordance with, for example, the following four conditions, and flow IDs may be categorized into the first to fourth lists in accordance with the priorities 1 to 4. In addition, it is assumed that the order of the magnitudes of priorities correspond to the order of 1 to 4 (in other words, the priority 1 is the highest, and the priority 4 is the lowest).

Priority 1: the priority condition is satisfied when a credit is paid out from the scheduler unit 6. Priority 2: the priority condition is satisfied when a packet is stored in one of the queues 511 to 513 or when a packet is read out from one of the queues 511 to 513. Priority 3: the priority condition is unsatisfied when a credit is paid out from the scheduler unit 6. Priority 4: the priority condition is unsatisfied when a packet is stored in one of the queues 511 to 513 or when a packet is read out from one of the queues 511 to 513.

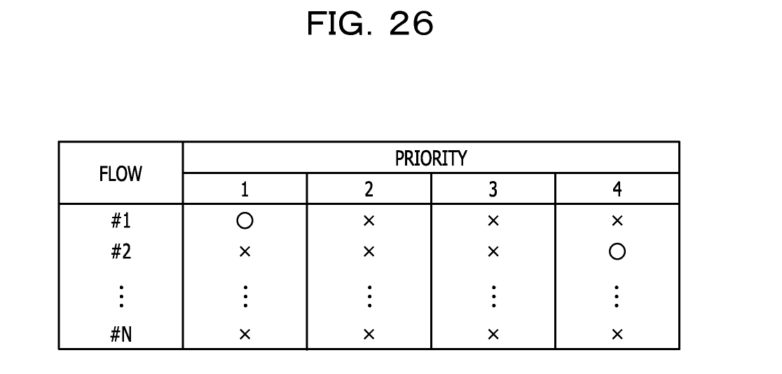

FIG. 26 illustrates an example of a registration management table in a fourth embodiment. In FIG. 26, a circle (see “◯”) indicates that the relevant flow ID is registered, and an x-mark (see “x”) indicates that the relevant flow ID is not registered.

In the present example, each flow ID is registered in one of the priorities 1 to 4, in other words, one of the first to fourth lists, or is registered in none of the lists. Since the flow #1 corresponds to the priority 1, the flow #1 is registered in the first list, and the flow #2 corresponds to the priority 4, the flow #1 is registered in the fourth list. In addition, the priority of the flow #N is not determined, and the flow #N is registered in none of the lists. This state of being unregistered is able to occur in, for example, a case where the credit counter of the flow #N is a negative value or a case where the queue 513 is empty.

The registration processing unit 54a manages a registration state so that the registration destinations of each flow ID become one point at a maximum. In other words, the registration processing unit 54a avoids the double registration of each flow ID. By referencing the registration management table, the registration processing unit 54a determines whether or not the registration of a flow ID is to be changed.

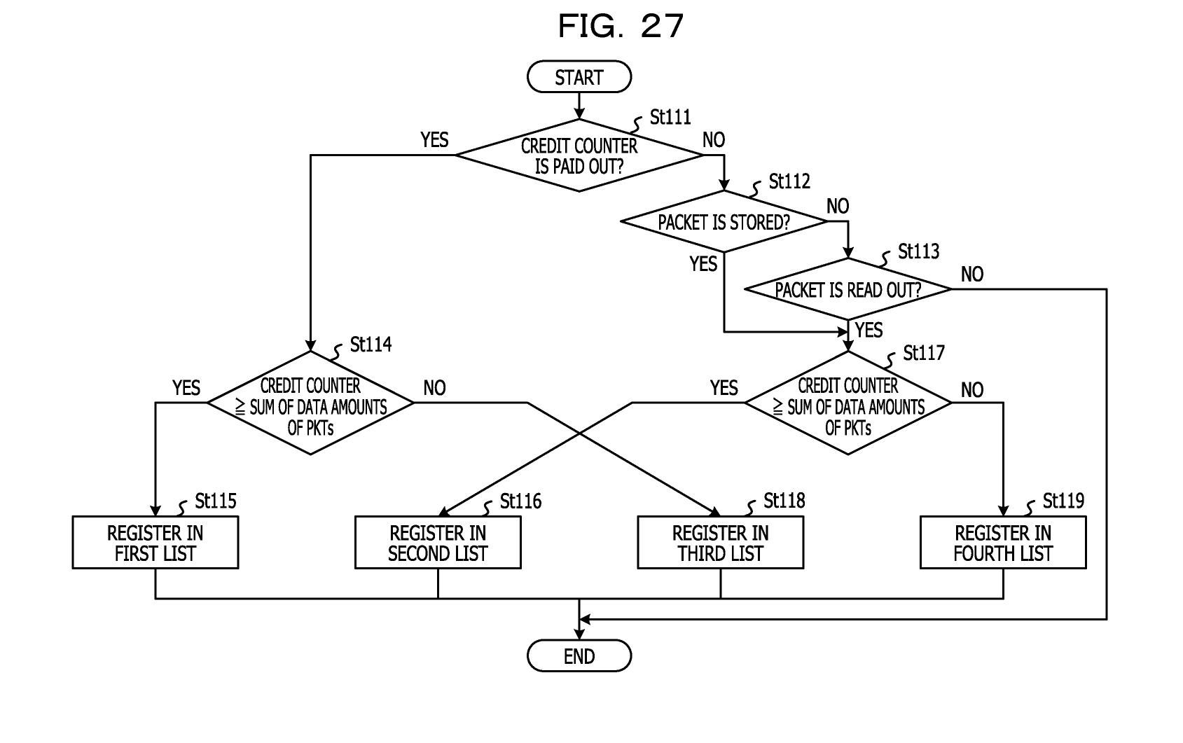

FIG. 27 is a flowchart of registration processing in the fourth embodiment. First, the registration processing unit 54a determines whether or not the scheduler unit 6 pays out a credit (step St111).

In a case where the scheduler unit 6 pays out a credit (step St111: Yes), the registration processing unit 54a determines whether or not one of the queues 511 to 513 that corresponds to the corresponding flow ID satisfies “a credit counter≧the sum of the data amounts of packets” (the priority condition) (step St114). At this time, the registration processing unit 54a acquires the credit counter from the credit counter unit 52, and acquires the sum of the data amounts of packets, in other words, the accumulated amount of packets, from the accumulated-amount monitoring unit 56.

In a case where the priority condition is satisfied (step St114: Yes), the registration processing unit 54a registers the corresponding flow ID in the first list (step St115), and terminates the processing. On the other hand, in a case where the priority condition is not satisfied (step St114: No), the registration processing unit 54a registers the corresponding flow ID in the third list (step St118), and terminates the processing.

In addition, in a case where the scheduler unit 6 pays out no credit (step St111: No), the registration processing unit 54a determines whether or not a packet is stored in the one of the queues 511 to 513 (step St112). In a case where the packet is not stored in the one of the queues 511 to 513 (step St112: No), the registration processing unit 54a determines whether or not a packet is read out from the one of the queues 511 to 513 (step St113).

In a case where the packet is not read out from the one of the queues 511 to 513 (step St113: No), the registration processing unit 54a terminates the processing. On the other hand, in a case where the packet is read out from the one of the queues 511 to 513 (step St113: Yes), the registration processing unit 54a determines whether or not the one of the queues 511 to 513 that corresponds to the corresponding flow ID satisfies “a credit counter≧the sum of the data amounts of packets” (the priority condition) (step St117). In a case where the packet is stored in the one of the queues 511 to 513 (step St112: Yes), the registration processing unit 54a determines whether or not the priority condition is satisfied (step St117).

In a case where the priority condition is satisfied (step St117: Yes), the registration processing unit 54a registers the corresponding flow ID in the second list (step St116), and terminates the processing. On the other hand, in a case where the priority condition is not satisfied (step St117: No), the registration processing unit 54a registers the corresponding flow ID in the fourth list (step St119), and terminates the processing. In this way, the registration processing is performed.

In this way, when the scheduler unit 6 assigns a credit to one of the plural queues 511 to 513, the registration processing unit 54a determines whether or not the corresponding queue satisfies the priority condition. In addition, in a case where the corresponding queue satisfies the priority condition, the registration processing unit 54a registers the corresponding flow ID in the first list in order of satisfying the readout condition. On the other hand, in a case where the corresponding queue does not satisfy the priority condition, the registration processing unit 54a registers the corresponding flow ID in the third list in order of satisfying the readout condition.

In addition, in a case where the readout processing unit 53a reads out one or more packets from one of the plural queues 511 to 513 or in a case where one or more packets are stored in one of the plural queues 511 to 513, the registration processing unit 54a determines whether or not the corresponding queue satisfies the priority condition. In addition, in a case where the corresponding queue satisfies the above-mentioned priority condition, the registration processing unit 54a registers the corresponding flow ID in the second list in order of satisfying the readout condition. On the other hand, in a case where the corresponding queue does not satisfy the above-mentioned priority condition, the registration processing unit 54a registers the corresponding flow ID in the fourth list in order of satisfying the readout condition.

The readout processing unit 53a defines a priority order as the order of the first list, the second list, the third list, and the fourth, and acquires flow IDs from the first list, the second list, the third list, and the fourth list in accordance with the priority order. The readout processing unit 53a reads out one or more packets from a queue corresponding to the acquired flow ID, among the plural queues 511 to 513.

From this, it is possible for the readout processing unit 53a to flexibly read out a packet in accordance with not only whether or not the priority condition is satisfied but also the priority of a flow based on an event (storage of a packet, payout of a credit, or readout of a packet). In addition, in the present embodiment, the registration changing processing in the second embodiment (see FIG. 22), or the judgment processing for a prioritized queue, based on a credit in the third embodiment (see FIG. 25), may be used.

### Fifth Embodiment

While, in one of the embodiments described above, based on the above-mentioned priority condition, the registration processing unit 54a judges one of the input queues 511 to 513, in other words, a prioritized queue, to which a packet is input at a rate less than or equal to a readout rate based on a credit assigned by the scheduler unit 6, the registration processing unit 54a is not limited to this. For example, based on an execution result of policing in the policer 81 within the input processing unit 912, the registration processing unit 54a may judge a prioritized queue.

As for a policing function, a method such as “2-rate 3-color” is specified based on, for example, “Metro Ethernet Forum (MEF) 10” and “Request For Comments (RFC) 2698”. In the “2-rate 3-color” method, two policers corresponding to a committed information rate (CIR) serving as a guaranteed bandwidth and an excess information rate (EIR) serving as a best effort bandwidth are used. In addition, based on results of policing of the two policers, color information indicating the level of an input rate (bandwidth) is determined for each packet (a so-called “2-rate 3-color meter”). In addition, the CIR is smaller than the EIR.

The color information of a packet input at a rate (flow rate) less than or equal to the CIR is determined as “Green”, and the color information of a packet input at a rate greater than the CIR and less than or equal to the EIR is determined as “Yellow”. Furthermore, the color information of a packet input at a rate greater than the EIR is determined as “Red”.

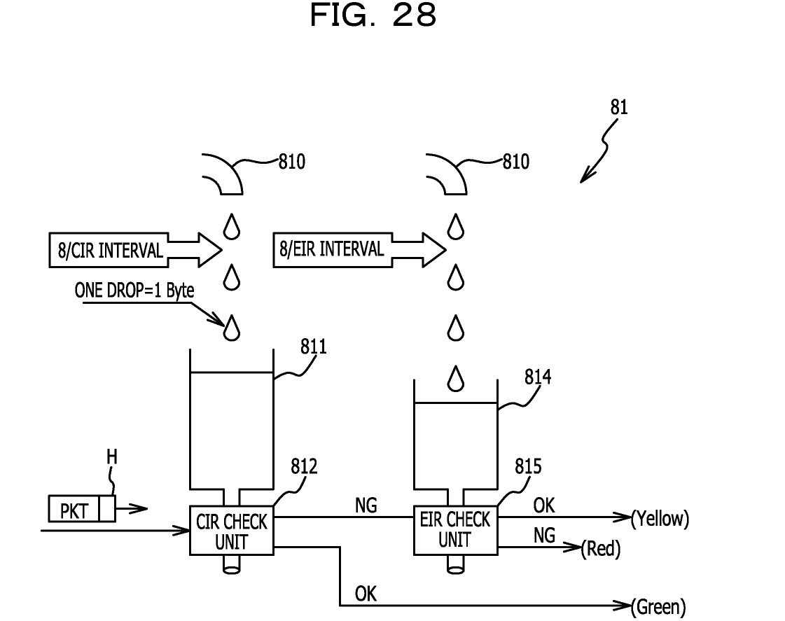

FIG. 28 is a configuration diagram illustrating a concept of a bandwidth determination function of the policer 81. The policer 81 includes a first supply source 810 that supplies a token to be used for the policing function of the CIR, a first token bucket 811 that retains the relevant token, and a CIR check unit 812 that checks whether or not the input rate of a packet is greater than or equal to the CIR. In addition, the policer 81 includes a second supply source 813 that supplies a token to be used for the policing function of the EIR, a second token bucket 814 that retains the relevant token, and an EIR check unit 815 that checks whether or not the input rate of a packet is less than or equal to the EIR.

In FIG. 28, the first supply source 810 is described as a faucet, and the token supplied by the first supply source 810 is described as drops of water output from the faucet. The first supply source 810 supplies drops of water to the first token bucket 811 at intervals of 8/CIR with one drop as 1 (Byte).

In addition, the second supply source 813 is described as a faucet, and the token supplied by the second supply source 813 is described as drops of water output from the faucet. The second supply source 813 supplies drops of water to the second token bucket 814 at intervals of 8/EIR with one drop as 1 (Byte).

Based on the retained amount of the token retained in the first token bucket 811, the CIR check unit 812 checks, for each packet (PKT), whether or not the input rate of the packet is less than or equal to the CIR. In a case where the input rate is less than or equal to the CIR (see “OK”), the policer 81 determines that the color information of the packet is “Green”.

On the other hand, in a case where the input rate is larger than the CIR (see “NG”), based on the retained amount of the token retained in the second token bucket 814, the EIR check unit 815 checks, for each packet, whether or not the input rate of the packet is less than or equal to the EIR. In a case where the input rate is less than or equal to the EIR (see “OK”), the policer 81 determines that the color information of the packet is “Yellow”. In addition, in a case where the input rate is larger than the EIR (see “NG”), the policer 81 determines that the color information of the packet is “Red”.

The color information obtained by such determination processing is stored in, for example, a within-device header H assigned to a packet. In addition, the color information may be stored in a discard priority information field of a header of a packet when the color information is output from the communication device.

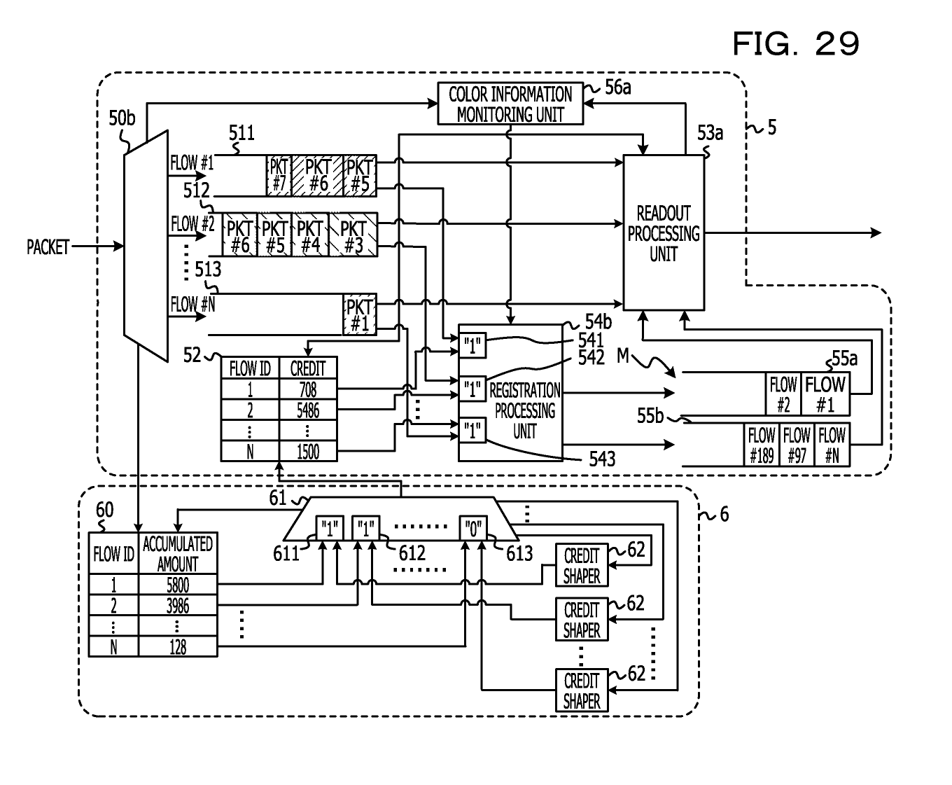

FIG. 29 is a configuration diagram illustrating the functional configuration of the output processing unit 913 in a fifth embodiment. In addition, in FIG. 29, the same symbol is assigned to a configuration in common with FIG. 16, and the description thereof will be omitted.

The output processing unit 913 includes the queue management unit 5 and the scheduler unit 6. The queue management unit 5 includes a distribution unit 50b, the plural queues 511 to 513, the credit counter unit 52, the readout processing unit 53a, a registration processing unit 54b, a color information monitoring unit 56a, and the memory (storage unit) M. The memory M stores therein the priority list 55a and the non-priority list 55b.

The scheduler unit 6 includes the accumulated-amount counter unit 60, the credit payout unit 61, and the plural credit shapers 62. In addition, the operation of the scheduler unit 6 is as described with reference to FIG. 4.

Based on flow IDs, the distribution unit 50b distributes input packets to the plural queues 511 to 513, and in addition to this, the distribution unit 50b acquires pieces of color information of the within-device headers H of packets input to the individual queues 511 to 513, and notifies the color information monitoring unit 56a of the pieces of color information. Based on the notification of the color information from the distribution unit 50b, the color information monitoring unit 56a monitors the color information of each of the flows #1 to #N.

The color information monitoring unit 56a notifies the registration processing unit 54b of the color information of each of the flows #1 to #N. Based on the color information, the registration processing unit 54b judges the priority of each flow. More specifically, the registration processing unit 54b judges, as a prioritized queue, a queue out of the plural queues 511 to 513, the queue accumulating therein a packet whose color information is “Green”, and registers the corresponding flow ID in the prioritized queue 55a in order of satisfying the above-mentioned readout condition. In addition, the registration processing unit 54b judges, as a non-prioritized queue, a queue accumulating therein a packet whose color information is “Yellow” or “Red”, and registers the corresponding flow ID in the non-prioritized queue 55b in order of satisfying the above-mentioned readout condition.

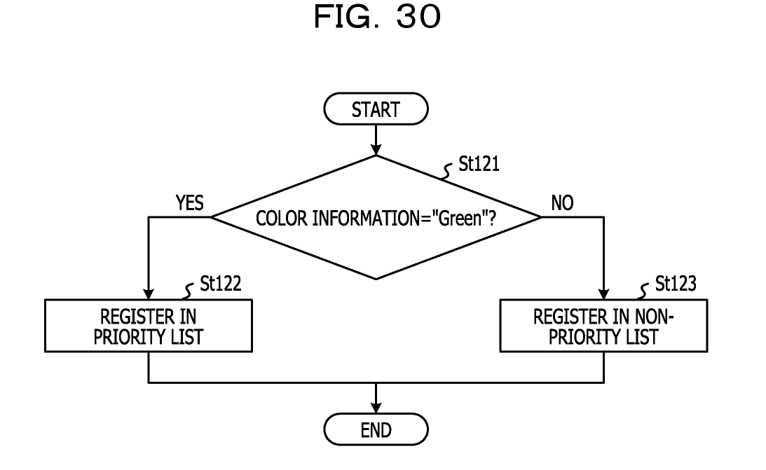

FIG. 30 is a flowchart of registration processing in the fifth embodiment. First, the registration processing unit 54b determines whether or not the color information of a packet of the corresponding flow is “Green” (step St121).

In a case where the color information is “Green” (step St121: Yes), the registration processing unit 54b registers the corresponding flow ID in the priority list 55a (step St122), and terminates the processing. On the other hand, in a case where the color information is “Yellow” or “Red” (step St121: No), the registration processing unit 54b registers the corresponding flow ID in the non-priority list 55b (step St123), and terminates the processing. In this way, the registration processing is performed.

As described above, in the present embodiment, the policer (rate detection unit) 81 detects the input rate of a packet, as the color information. The registration processing unit 54b judges, as a prioritized queue, a queue out of the plural queues 511 to 513, the queue accumulating therein a packet whose input rate detected by the policer 81 is less than or equal to the predetermined value (CIR), in other words, a packet whose color information is “Green”.

Accordingly, using the color information assigned to a packet, it is possible for the registration processing unit 54b to easily judge a prioritized queue. In addition, while, in the present embodiment, a flow ID corresponding to a packet whose color information is “Green” is registered in the priority list 55a, and a flow ID corresponding to a packet whose color information is “Yellow” or “Red” is registered in the non-priority list 55b, the registration of a flow ID is not limited to this. For example, three lists corresponding to the respective pieces of color information of “Green”, “Yellow”, and “Red” may be provided, and a flow ID may be registered in a list corresponding to the color information of the corresponding packet, among the three relevant lists. In addition, in the present embodiment, the registration changing processing in the second embodiment (see FIG. 22) or the judgment processing for a prioritized queue, based on a credit in the third embodiment (see FIG. 25), may be used.

### Sixth Embodiment

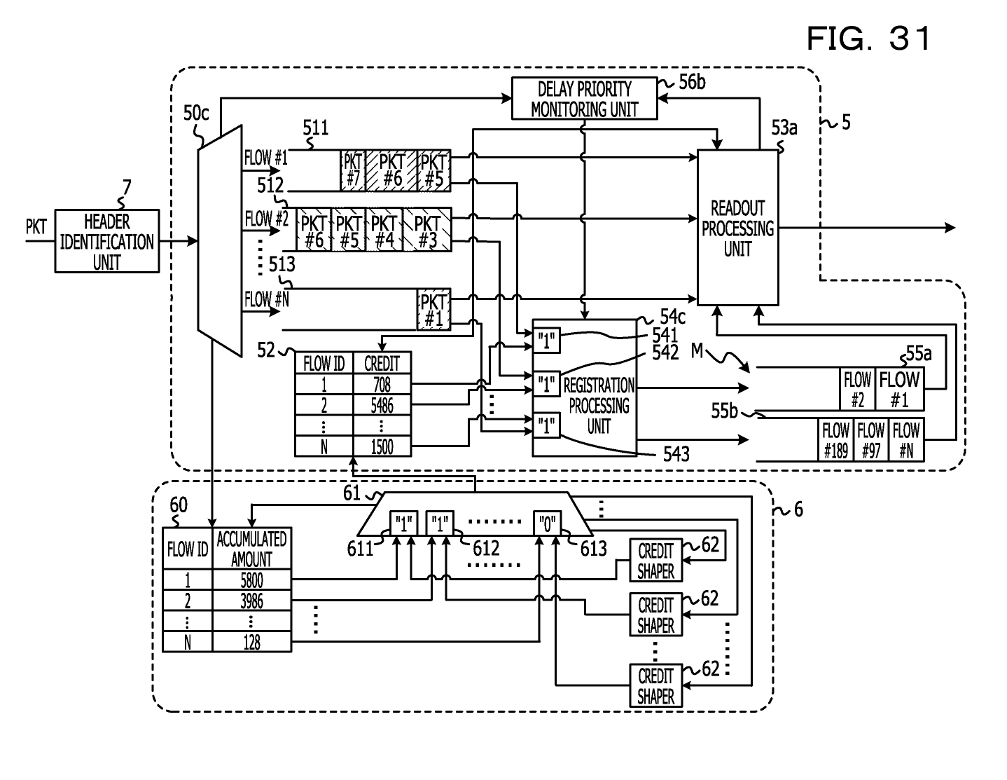

A judgment unit for a prioritized queue is not limited to the above-mentioned content, for example, the type of packet is identified, and the prioritized queue may be judged in accordance with the type of packet accumulated in a queue. FIG. 31 is a configuration diagram illustrating the functional configuration of the output processing unit 913 in a sixth embodiment. In addition, in FIG. 31, the same symbol is assigned to a configuration in common with FIG. 16, and the description thereof will be omitted.

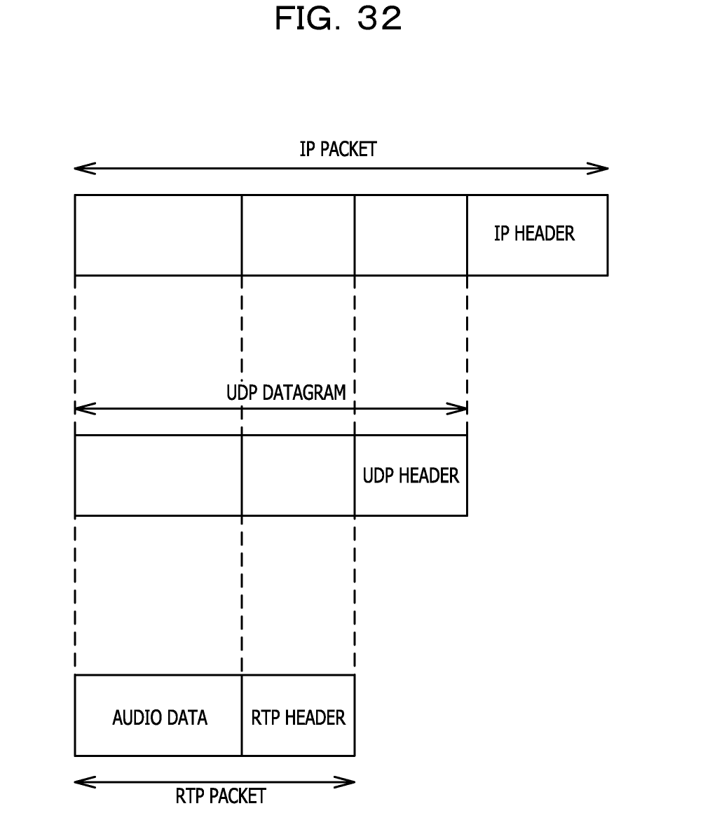

The output processing unit 913 includes a header identification unit 7, the queue management unit 5, and the scheduler unit 6. The header identification unit 7 identifies, for example, a packet of a VoIP. FIG. 32 is a configuration diagram illustrating the configuration of a packet of the VoIP.

In the VoIP, a user datagram protocol (UDP) is defined as an upper protocol, and a real-time transport protocol (RTP) is further defined as an upper protocol therefor. Therefore, a packet (IP packet) of the VoIP includes an IP header and a UDP datagram, and the UDP datagram includes a UDP header, and an RTP packet including a RTP header and audio data.

In a case of identifying the packet of the VoIP, the header identification unit 7 inserts delay priority information indicating “High”, in a within-device header assigned to the corresponding packet, and in a case of identifying another packet, the header identification unit 7 inserts delay priority information indicating “Low”, in a within-device header assigned to the corresponding packet. In a case where the delay priority information indicates “High”, the delay and the fluctuation of the corresponding packet are suppressed on a priority basis, and in a case where the delay priority information indicates “Low”, the delay and the fluctuation of the corresponding packet are suppressed on a low priority basis.

The queue management unit 5 includes a distribution unit 50c, the plural queues 511 to 513, the credit counter unit 52, the readout processing unit 53a, a registration processing unit 54c, a delay priority monitoring unit 56b, and the memory (storage unit) M. The memory M stores therein the priority list 55a and the non-priority list 55b.

The scheduler unit 6 includes the accumulated-amount counter unit 60, the credit payout unit 61, and the plural credit shapers 62. In addition, the operation of the scheduler unit 6 is as described with reference to FIG. 4.

Based on flow IDs, the distribution unit 50c distributes input packets to the plural queues 511 to 513, and in addition to this, the distribution unit 50c acquires pieces of delay priority information of the within-device headers of packets input to the individual queues 511 to 513, and notifies the delay priority monitoring unit 56b of the pieces of delay priority information. Based on the pieces of delay priority information from the distribution unit 50c, the delay priority monitoring unit 56b monitors the delay priority information of each of the flows #1 to #N.

The delay priority monitoring unit 56b notifies the registration processing unit 54c of the delay priority information of each of the flows #1 to #N. Based on the delay priority information, the registration processing unit 54c judges the priority of each flow. More specifically, the registration processing unit 54c judges, as a prioritized queue, a queue out of the plural queues 511 to 513, the queue accumulating therein a packet whose delay priority information is “High”, and the registration processing unit 54c registers the corresponding flow ID in the prioritized queue 55a in order of satisfying the above-mentioned readout condition. In addition, the registration processing unit 54c judges, as a non-prioritized queue, a queue accumulating therein a packet whose delay priority information is “Low”, and registers the corresponding flow ID in the non-prioritized queue 55b in order of satisfying the above-mentioned readout condition.

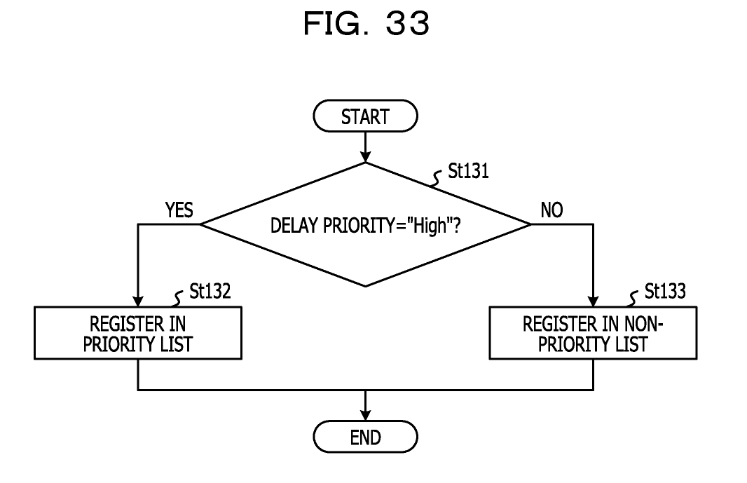

FIG. 33 is a flowchart of registration processing in the sixth embodiment. First, the registration processing unit 54c determines whether or not the delay priority information of a packet of the corresponding flow is “High” (step St131).

In a case where the delay priority information is “High” (step St131: Yes), the registration processing unit 54c registers the corresponding flow ID in the priority list 55a (step St132), and terminates the processing. On the other hand, in a case where the delay priority information is “Low” (step St131: No), the registration processing unit 54c registers the corresponding flow ID in the non-priority list 55b (step St133), and terminates the processing. In this way, the registration processing is performed.

As described above, the header identification unit (identification unit) 7 identifies a specific type of packet (in the above-mentioned example, a packet of the VoIP). The registration processing unit 54c judges, as a prioritized queue, a queue out of the plural queues 511 to 513, the queue accumulating therein the specific type of packet identified by the header identification unit 7.

Accordingly, the type of packet identified by the header identification unit 7 is defined as a packet of a bandwidth-guaranteed flow such as the VoIP, and hence, it is possible for the registration processing unit 54c to easily judge a prioritized queue in accordance with a type identified by the header identification unit 7. In addition, in the present embodiment, the registration changing processing in the second embodiment (see FIG. 22) or the judgment processing for a prioritized queue, based on a credit in the third embodiment (see FIG. 25), may be used.

(Simulation Result)

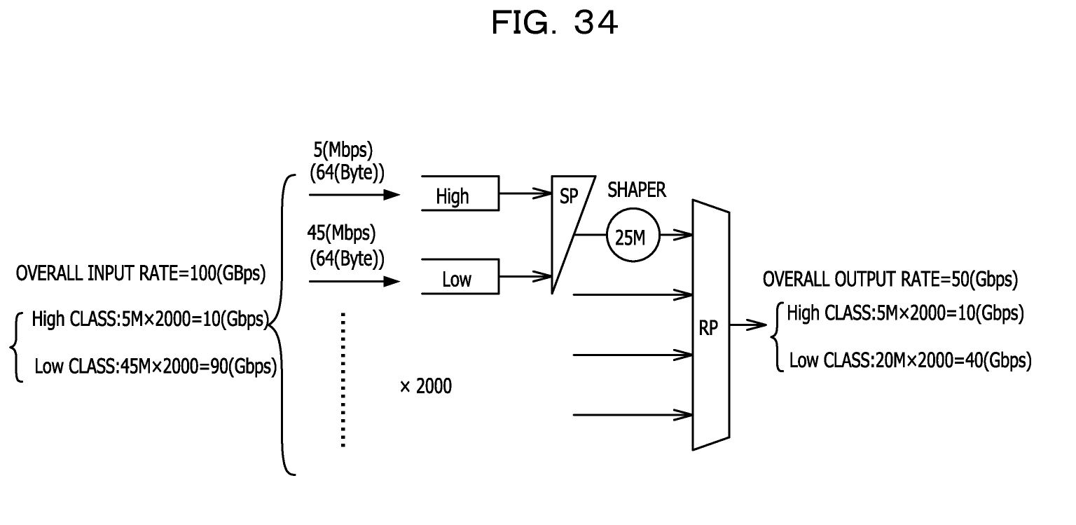

Next, advantages of a communication device according to an embodiment will be descried using simulation results. FIG. 34 is a configuration diagram illustrating a simulation model.

In the present simulation, 2000 groups of flows of a High class and a Low class are assumed as the flows of input packets. The flows of the High class are bandwidth-guaranteed traffics such as, for example, audio system data or finance system data, and packets whose lengths are each 64 (Byte) are input to a queue at a rate of 5 (Mbps). On the other hand, the flows of the Low class are, for example, best effort traffics, and packets whose lengths are each 64 (Byte) are input to a queue at a rate of 45 (Mbps).

The flow of the High class of each group is controlled on a strict priority basis so as to be given priority over the flow of the Low class of the same group and output (see “strict priority (SP)”). A shaper (corresponding to the credit shaper 62) performs shaping on each flow so that the sum of the output rates of the flows of the High class and the Low class becomes 25 (Mbps). In addition, control between the groups of the High class and the Low class is performed in accordance with, for example, a round-robin method (see “round robin (RR)”).

From this, both the input rate and the output rate of the flow of the High class become 5 (Mbps), and while the input rate of the flow of the Low class is 45 (Mbps), the remaining 20 (Mbps) (=25-5) is assigned as the output rate of the flow of the Low class. In other words, packets of the flow of the High class are input to a queue at a rate less than or equal to a readout rate based on a credit assigned by the scheduler unit 6. In addition, packets of the flow of the Low class are input to a queue at a rate larger than a readout rate based on a credit assigned by the scheduler unit 6. In addition, since there are 2000 groups of the High class and the Low class, an overall output rate is 50 (Gbps) while an overall input rate is 100 (Gbps).

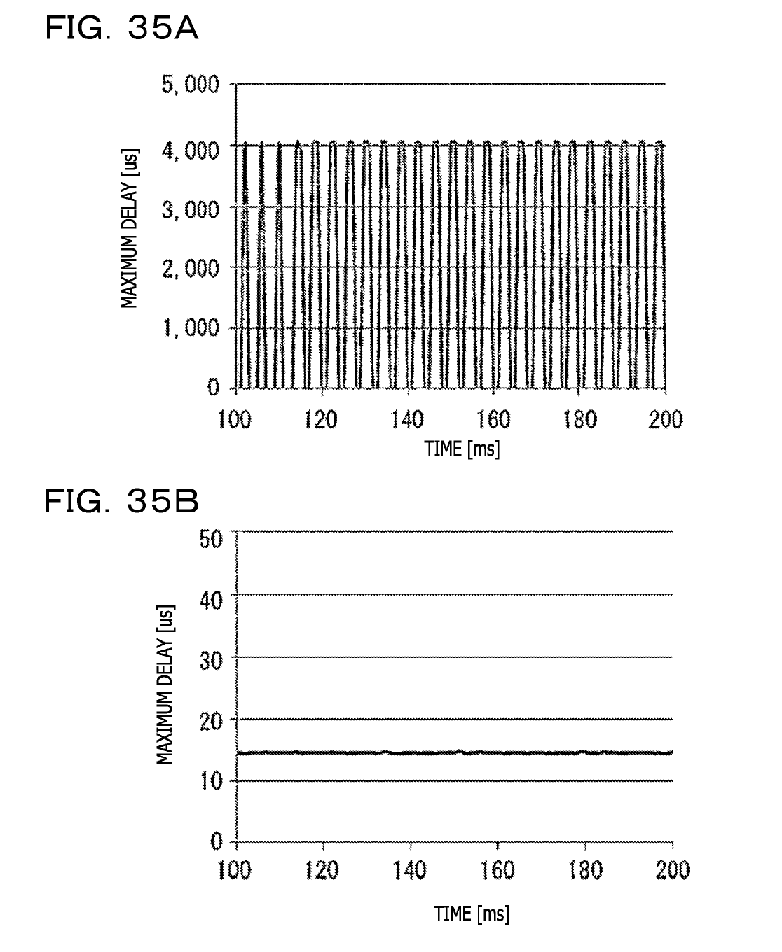

FIGS. 35A and 35B are graphs illustrating simulation results of maximum delay times of packets in a comparative example and an embodiment. FIG. 35A illustrates a simulation result based on the above-mentioned second comparative example, and FIG. 35B illustrates a simulation result based on one of the above-mentioned embodiments.

In each of FIG. 35A and FIG. 35B, a horizontal axis indicates a simulation time, and a vertical axis indicates a maximum delay time of a packet of the above-mentioned flow of the High class. In addition, the simulation time ranges from 100 to 200 (ms) after inputting of the flow is started.

As will be understood by referring to FIG. 35A, a delay of a maximum of about 4 (ms) occurs in the comparative example. In the present simulation, since the packet lengths of the flows of the Low class are each 64 (Byte) (in other words, short packets), the absolute values of credit counters of individual flows are small even if credits are put into debt statuses. However, if the debt statuses of credits of the 2000 flows of the Low class are superimposed on one another, packets of the flows of the Low class occupy the bandwidth of an output port before packets of the flows of the High class are output (see FIG. 14). Therefore, the maximum delay time of packets of the flows of the High class is increased, and communication quality is deteriorated.

In contrast, as will be understood by referring to FIG. 35B, a maximum delay time is stable at about 0.01 (ms). As just described, according to the embodiment, there is improved the communication quality of a flow input to a queue at a rate less than or equal to a readout rate based on a credit assigned by the scheduler unit 6, in such a manner as the flow of the High class.

As described above, the communication device according to the embodiment includes the plural queues 511 to 513 that accumulate therein one or more packets, the scheduler unit 6, one of the judgment units (registration processing units) 54a to 54c, and the readout processing unit 53a. The scheduler unit 6 assigns the permissible amount of readout (a credit) to each of the plural queues 511 to 513.

From among the plural queues 511 to 513, the judgment units 54a to 54c each judge, as a prioritized queue, a queue to which packets are input at a rate less than or equal to a readout rate based on the permissible amount of readout assigned by the scheduler unit 6. The readout processing unit 53a prioritizes a prioritized queue, and reads out, by consuming the permissible amount of readout, one or more packets from one of the plural queues 511 to 513 in order of satisfying the readout condition relating to the permissible amount of readout of the corresponding queue and the data amount of one or more packets accumulated in the corresponding queue.

According to the communication device according to the embodiment, the readout processing unit 53 reads out packets from one of the plural queues 511 to 513 in order of satisfying the readout condition relating to the permissible amount of readout of the corresponding queue and the data amount of one or more packets accumulated in the corresponding queue. Therefore, it is possible for the readout processing unit 53 to select one of the queues 511 to 513 and read out a packet with a high throughput, using simple processing whose load is light, without performing search processing for which much time is taken.

In addition, according to the communication device according to the embodiment, from among the plural queues 511 to 513, the judgment units 54a to 54c each identify, as a prioritized queue, a queue where the input rate of packets is less than or equal to a readout rate based on the permissible amount of readout. The readout processing unit 53a prioritizes the prioritized queue, and reads out a packet from the plural queues 511 to 513.

Therefore, a packet whose input rate is controlled so as to be less than or equal to a given level in such a manner as a bandwidth-guaranteed traffic is read out from the queues 511 to 513 while being prioritized over other packets. On the other hand, a packet whose input rate is not controlled and exceeds an output rate in such a manner as a best effort traffic is read out from the queues 511 to 513 after the above-mentioned packet. Accordingly, according to the communication device according to the embodiment, it is possible to improve communication quality.

In addition, a packet scheduling method according to the embodiment includes the following processes (1) to (3):

(1) a process that assigns the permissible amount of readout (a credit) to each of the plural queues 511 to 513 each accumulating therein one or more packets,

(2) a process that judges, as a prioritized queue, a queue to which packets are input at a rate less than or equal to a readout rate based on the assigned permissible amount of readout, from among the plural queues 511 to 513, and

(3) a process that prioritizes the prioritized queue, and reads out, by consuming the permissible amounts of readout, packets from the plural queues 511 to 513 in order of satisfying the readout conditions relating to the permissible amounts of readout of individual queues and the data amounts of packets accumulated in individual queues.

Since the packet scheduling method according to the embodiment has the same configuration as that of the above-mentioned communication device, the packet scheduling method achieves the above-mentioned function effect.

While, as above, the contents of the present technology have been specifically described with reference to preferred embodiments, it is obvious that those skilled in the art may adopt various modified forms, based on the basic technological thought and the teaching of the present technology.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An apparatus comprising:
a memory; and
a processor coupled to the memory and configured to:
provide an acceptable read amount with a plurality of queues;
discern one or more queues from among the plurality of queues as one or more prioritized queues, the one or more prioritized queues receiving packets within a receiving rate that equals to or is less than a reading rate depending on the acceptable read amount; and
read one or more packets from the plurality of queues, with prioritizing the one or more prioritized queues and consuming the acceptable read amount, in order satisfying a read condition being associated with the acceptable read amount and an amount of stored packets.

2. The apparatus of claim 1, wherein
the one or more prioritized queues satisfying a priority condition that the acceptable read amount is equal to or larger than the amount of the stored packets.

3. The apparatus of claim 2, wherein
the processor is further configured to:
register identifiers of the one or more prioritized queues in a first list in the order satisfying the read condition;
register identifiers of other queues other than the one or more prioritized queues in a second list in the order satisfying the read condition;
obtain one of identifiers from the first list in priority to the second list; and
read the one or more packets from a queue corresponding to the one of the identifiers.

4. The apparatus of claim 3, wherein
the processor is further configured to:
determine whether a first queue, whose identifier is registered in the second list and which is provided with the acceptable read amount, satisfies the priority condition; and
register the identifier of the first queue in the first list when it is determined that the first queue satisfies the priority condition.

5. The apparatus of claim 3, wherein
the processor is further configured to:
determine whether a second queue, whose identifier is registered in the first list and from which the one or more packets is read or which stores at least one packet, satisfies the priority condition; and
register the identifier of the second queue in the second list when it is determined that the first queue does not satisfy the priority condition.

6. The apparatus of claim 2, wherein
the processor is further configured to discern a queue, having an acceptable read amount which equals to or is larger than a specific amount, as the one of the prioritized queues.

7. The apparatus of claim 2, wherein
the processor is further configured to:
register a first identifier of a first queue in a first list when it is determined that the first queue, which is provided with the acceptable read amount, satisfies the priority condition;
register a second identifier of a second queue in a third list when it is determined that the second queue, which is provided with the acceptable read amount, does not satisfy the priority condition;
register a third identifier of a third queue in the second list when it is determined that the third queue, from which the one or more packets is read or which stores at least one packet, satisfies the priority condition; and
register a fourth identifier of a fourth queue in the fourth list when it is determined that the fourth queue, from which the one or more packets is read or which stores at least one packet, does not satisfy the priority condition,
wherein the first list, the second list, the third list and the fourth list is prioritized in descending order of priority.

8. The apparatus of claim 1, wherein
the read condition is satisfied when both of the acceptable read amount and the one or more packets is larger than zero.

9. The apparatus of claim 1, wherein
the processor is further configured to discern a queue, whose receiving rate equals to or is less than a specific rate and in which stores at least one packet, as the one of the prioritized queues.

10. The apparatus of claim 1, wherein
the processor is further configured to discern a queue, which stores at least one packet whose kind is specific, as the one of the prioritized queues.

11. A method comprising:
providing an acceptable read amount with a plurality of queues;
discerning one or more queues from among the plurality of queues as one or more prioritized queues, the one or more prioritized queues receiving packets within a receiving rate that equals to or is less than a reading rate depending on the acceptable read amount; and
reading one or more packets from the plurality of queues, with prioritizing the one or more prioritized queues and consuming the acceptable read amount, in order satisfying a read condition being associated with the acceptable read amount and an amount of stored packets.

12. The method of claim 11, wherein
the one or more prioritized queues satisfying a priority condition that the acceptable read amount is equal to or larger than the amount of the stored packets.

13. The method of claim 12, further comprising:
registering identifiers of the one or more prioritized queues in a first list in the order satisfying the read condition;
registering identifiers of other queues other than the one or more prioritized queues in a second list in the order satisfying the read condition;
obtaining one of identifiers from the first list in priority to the second list; and
reading the one or more packets from a queue corresponding to the one of the identifiers.

14. The method of claim 13, further comprising:
determining whether a first queue, whose identifier is registered in the second list and which is provided with the acceptable read amount, satisfies the priority condition; and
registering the identifier of the first queue in the first list when it is determined that the first queue satisfies the priority condition.

15. The method of claim 13, further comprising:
determining whether a second queue, whose identifier is registered in the first list and from which the one or more packets is read or which stores at least one packet, satisfies the priority condition; and
registering the identifier of the second queue in the second list when it is determined that the first queue does not satisfy the priority condition.

16. The method of claim 12, further comprising:
discerning a queue, having an acceptable read amount which equals to or is larger than a specific amount, as the one of the prioritized queues.

17. The method of claim 12, further comprising:
registering a first identifier of a first queue in a first list when it is determined that the first queue, which is provided with the acceptable read amount, satisfies the priority condition;
registering a second identifier of a second queue in a third list when it is determined that the second queue, which is provided with the acceptable read amount, does not satisfy the priority condition;
registering a third identifier of a third queue in the second list when it is determined that the third queue, from which the one or more packets is read or which stores at least one packet, satisfies the priority condition; and
registering a fourth identifier of a fourth queue in the fourth list when it is determined that the fourth queue, from which the one or more packets is read or which stores at least one packet, does not satisfy the priority condition,
wherein the first list, the second list, the third list and the fourth list is prioritized in descending order of priority.

18. The method of claim 11, wherein
the read condition is satisfied when both of the acceptable read amount and the one or more packets is larger than zero.

19. The method of claim 11, further comprising:
discerning a queue, whose receiving rate equals to or is less than a specific rate and in which stores at least one packet, as the one of the prioritized queues.

20. The method claim 11, further comprising:
discerning a queue, which stores at least one packet whose kind is specific, as the one of the prioritized queues.
